(19) United States
(12) Patent Application Publication
(10) Pub. No.: US 2026/0178036 A1
(43) Pub. Date: Jun. 25, 2026

(54) SYSTEMS AND METHODS FOR EMBEDDING FEATURE DATA IN COMPUTER READABLE MAPS FOR IMPROVED CONTROL AND INSIGHT GENERATION

(71) Applicant: Brain Corporation, San Diego, CA (US)

(72) Inventors: Sahil DHAYALKAR, San Diego, CA (US); Eashan GUPTA, San Diego, CA (US); Mihir SALOT, San Diego, CA (US)

(21) Appl. No.: 19/422,995

(22) Filed: Dec. 17, 2025

Related U.S. Application Data
(60) Provisional application No. 63/736,211, filed on Dec. 19, 2024.

(51) Int. Cl. G05D 1/246; G05B 13/02; G05D 1/2285; G05D 101/15; G06F 40/40; G06T 7/73; G06T 11/26; G06V 10/44; G06V 10/74; G06V 10/75; G06V 10/82; G06V 20/58

(52) U.S. Cl. CPC G05D 1/246; G05B 13/027; G05D 1/2285; G06F 40/40; G06T 7/73; G06T 11/26; G06V 10/44; G06V 10/751; G06V 10/761; G06V 10/82; G06V 20/58; G05D 2101/15; G06T 2207/20084; G06T 2207/30261

(57) ABSTRACT

A method for localizing a mobile robot using a feature-embedded map includes detecting a power-on event of the robot at an unknown location, capturing a first image via a camera mounted on the robot, and encoding the first image into a first feature embedding vector using an image encoder. The method accesses a computer-readable map comprising a plurality of feature embedding vectors generated from images previously captured by the robot during prior navigation, where each feature embedding vector is stored at a respective physical location coordinate. The method determines similarity between the first feature embedding vector and the plurality of feature embedding vectors, identifies matching vectors exceeding a similarity threshold, and localizes the robot by correlating the unknown location with the physical location coordinates of the matching vectors. This enables autonomous navigation without QR codes, barcodes, or structural landmarks.

### CROSS-REFERENCE TO RELATED APPLICATION

This application claims priority under 35 U.S.C. § 119 (e) to U.S. Provisional Patent Application No. 63/736,211, filed on Dec. 19, 2024, which is hereby incorporated by reference in its entirety.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND

### Technological Field

The present application relates generally to robotics, and more specifically to systems and methods embedding feature data in maps for improved control and insight generation for robots as they maneuver an environment.

### SUMMARY

Currently, robots navigate and sense a plurality of features within their environment. Often these features are only situationally valuable, wherein programming a robot to be able to detect a wide variety of specific features is a cumbersome task which requires the designer(s) to anticipate the features of interest. This generally limits feature detection to only specific, predictable hazards such as wires, a pile of papers resting flat on the floor, or other highly specific classes of things which the robot should avoid and are best detected via imagery (i.e., as opposed to LiDAR). As such, there is a need to improve the conventional technology to include detection of features in a computer readable map.

The present disclosure aims to expand the number of possible features that are able to be detected within a computer readable map, which may be produced by a robot, while minimizing the specific programming needs required for robotic devices. These features may further enhance the computer readable map with additional information, which may be insightful to humans operating or programming the robot, and/or may be used to more specifically guide the robot using features specified in natural human language (e.g., ‘drive down aisle four and wait near the exit’).

In some aspects, the techniques described herein relate to a method for localizing a mobile robot in a physical environment without requiring artificial markers, including: powering on the mobile robot at an unknown location within the physical environment; capturing, via a camera physically mounted on the mobile robot, a first image of the physical environment from the unknown location; encoding, by an image encoder implemented on a processor of the mobile robot, the first image into a first feature embedding vector; accessing, from a memory of the mobile robot, a computer-readable map representing the physical environment, the map including a plurality of feature embedding vectors generated from images previously captured by the mobile robot during prior navigation within the physical environment, wherein each feature embedding vector is stored at a respective physical location coordinate in the map; determining a degree of similarity between the first feature embedding vector and each of the plurality of feature embedding vectors in the computer-readable map; identifying, based on the degree of similarity, one or more matching feature embedding vectors from the computer-readable map that exceed a similarity threshold, wherein the identified matching feature embedding vectors correspond to one or more pixels in the first image that depict features at the unknown location; and localizing the mobile robot at the unknown location based on position of the mobile robot relative to the one or more pixels determined to have the degree of similarity, wherein the localizing enables the mobile robot to autonomously navigate within the physical environment.

In some aspects, the techniques described herein relate to a method, wherein, the image encoder is a pre-trained neural network model configured to encode images into feature embedding vectors, and the computer-readable map is generated by providing, to the image encoder, a plurality of images previously captured by the mobile robot at locations measured by the robot during a prior mapping traversal of the physical environment.

In some aspects, the techniques described herein relate to a method, further including: receiving, at a user device communicatively coupled to the mobile robot, a natural language query describing one or more features within the physical environment; providing the natural language query to a text encoder to generate a query feature embedding vector; comparing the query feature embedding vector to the plurality of feature embedding vectors in the computer-readable map; identifying one or more locations in the computer-readable map where feature embedding vectors are substantially similar to the query feature embedding vector; and directing the mobile robot to navigate to one of the identified locations based on the natural language query.

In some aspects, the techniques described herein relate to a method, wherein localizing the mobile robot further includes: projecting, from the camera via ray-casting, one or more rays through pixels of the first image corresponding to the identified matching feature embedding vectors; determining three-dimensional intersection points of the one or more rays with the physical environment; and refining the localization by correlating the intersection points with the respective physical location coordinate of the identified matching feature embedding vectors.

In some aspects, the techniques described herein relate to a method, further including: detecting a mapping inconsistency by comparing the first feature embedding vector to a previously stored feature embedding vector at the respective physical location coordinate; determining that the first feature embedding vector differs from the previously stored feature embedding vector by more than a threshold amount; and generating an alert or triggering a remapping operation to correct mapping errors in the computer-readable map.

In some aspects, the techniques described herein relate to a method, further including: creating a heat map of the physical environment by counting, for each of a plurality of pixel representing a discretized region of the physical environment, a number of times a feature embedding vector is projected into the pixel; encoding the count for each pixel with a visual indicator representing feature occurrence density; and storing the heat map in the computer-readable map to enable analysis of feature distribution throughout the physical environment.

In some aspects, the techniques described herein relate to a non-transitory computer-readable medium including computer-readable instructions stored thereon that, when executed by at least one processor of a mobile robot, cause the processor to: detect a power-on event of the mobile robot at an unknown location within a physical environment; receive, from a camera physically mounted on the mobile robot, a first image of the physical environment captured from the unknown location; encode the first image into a first feature embedding vector using an image encoder implemented on the processor; access, from a memory of the mobile robot, a computer-readable map representing the physical environment, the map including a plurality of feature embedding vectors generated from images previously captured by the mobile robot during prior navigation within the physical environment, wherein each feature embedding vector is stored at a respective physical location coordinate in the map; determine a degree of similarity between the first feature embedding vector and each of the plurality of feature embedding vectors in the computer-readable map; identify, based on the degree of similarity, one or more matching feature embedding vectors from the computer-readable map that exceed a similarity threshold, wherein the identified matching feature embedding vectors correspond to one or more pixels in the first image that depict features at the unknown location; and localize the mobile robot at the unknown location based on position of the mobile robot relative to the one or more pixels determined to have the degree of similarity, wherein the localizing enables the mobile robot to autonomously navigate within the physical environment.

In some aspects, the techniques described herein relate to a non-transitory computer-readable medium, wherein, the image encoder is a pre-trained neural network model stored in the memory, and the instructions further cause the processor to generate the computer-readable map by encoding a plurality of images previously captured by the mobile robot at locations measured by the robot during a prior mapping traversal of the physical environment using the image encoder.

In some aspects, the techniques described herein relate to a non-transitory computer-readable medium, wherein the computer-readable instructions further cause the processor to: receive, from a user device communicatively coupled to the mobile robot via a communication interface, a natural language query describing one or more features within the physical environment; encode the natural language query into a query feature embedding vector using a text encoder; compare the query feature embedding vector to the plurality of feature embedding vectors in the computer-readable map; identify one or more locations in the computer-readable map where feature embedding vectors are substantially similar to the query feature embedding vector; and transmit navigation instructions to an actuator of the mobile robot to autonomously navigate to one of the identified locations based on the natural language query.

In some aspects, the techniques described herein relate to a non-transitory computer-readable medium, wherein the computer-readable instructions further cause the processor to, refine the localization by: projecting, from the camera via ray-casting, one or more rays through pixels of the first image corresponding to the identified matching feature embedding vectors; calculating three-dimensional intersection points of the one or more rays with the physical environment; and correlating the intersection points with the respective physical location coordinate of the identified matching feature embedding vectors to determine a refined pose estimate of the mobile robot.

In some aspects, the techniques described herein relate to a non-transitory computer-readable medium, wherein the computer-readable instructions further cause the processor to: detect a mapping inconsistency by retrieving a previously stored feature embedding vector associated with the respective physical location coordinate; compare the first feature embedding vector to the previously stored feature embedding vector; determine that the first feature embedding vector differs from the previously stored feature embedding vector by more than a threshold amount; generate an alert signal indicating a mapping error; and trigger a remapping routine or transmit the alert to a remote monitoring system to correct mapping errors in the computer-readable map.

In some aspects, the techniques described herein relate to a non-transitory computer-readable medium, wherein the computer-readable instructions further cause the processor to: discretize the physical environment into a plurality of pixels; count, for each pixel, a number of times a feature embedding vector is projected into the pixel during localization process; generate a heat map by encoding each count with a visual indicator representing feature occurrence density; and store the heat map in the computer-readable map to enable analysis and visualization of feature distribution throughout the physical environment.

In some aspects, the techniques described herein relate to a non-transitory computer-readable medium, wherein the computer-readable instructions further cause the processor to: retrieve the similarity threshold from a configuration stored in the memory; dynamically adjust the similarity threshold based on environmental conditions, feature density, or map quality metrics; and apply the adjusted similarity threshold when identifying the one or more matching feature embedding vectors.

In some aspects, the techniques described herein relate to a non-transitory computer-readable medium, wherein the computer-readable instructions further cause the processor to: determine that the mobile robot is localized by identifying multiple matching feature embedding vectors at nearby physical location coordinates; update an odometry estimate of the mobile robot based on the localization; transmit correction signals to a navigation unit of the mobile robot to correct accumulated odometry drift; and resume autonomous navigation with improved localization accuracy.

In some aspects, the techniques described herein relate to a non-transitory computer-readable medium, wherein the computer-readable instructions further cause the processor to: capture a plurality of images over time from the camera as the mobile robot navigates the physical environment; encode each of the plurality of images into corresponding feature embedding vectors; store each feature embedding vector at the physical location coordinate where the corresponding image was captured; and continuously update the computer-readable map with newly generated feature embedding vectors to expand map coverage and improve localization robustness over successive traversals of the physical environment.

Exemplary embodiments described herein have innovative features, no single one of which is indispensable or solely responsible for their desirable attributes. Without limiting the scope of the claims, some of the advantageous features will now be further discussed below. One skilled in the art would appreciate that as used herein, the term robot may generally be referred to an autonomous vehicle or an object that travels a route, executes a task, or otherwise moves automatically upon executing or processing computer readable instructions.

These and other objects, features, and characteristics of the present disclosure, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosure. As used in the specification and in the claims, the singular form of “a”, “an”, and “the” include plural referents unless the context clearly dictates otherwise.

### BRIEF DESCRIPTION OF THE DRAWINGS

The disclosed aspects will hereinafter be described in conjunction with the appended drawings, provided to illustrate and not to limit the disclosed aspects, wherein like designations denote like elements.

FIG. 1A is a functional block diagram of a robot in accordance with some embodiments of this disclosure.

FIG. 1B is a functional block diagram of a controller or processor in accordance with some embodiments of this disclosure.

FIG. 2 is an exemplary machine learning model comprising a plurality of nodes and weights in accordance with some embodiments of this disclosure.

FIG. 3A depicts a training methodology for configuring an image encoder and a text encoder to detect if an image and textual prompt correspond to each other, according to an exemplary embodiment.

FIG. 3B depicts trained models being utilized to determine an image from a plurality of images which correspond to a given text prompt, according to an exemplary embodiment.

FIG. 4 depicts a computer readable map having a feature embedding vector encoded thereon, according to an exemplary embodiment.

FIG. 5 depicts a method for projecting feature data from an image space to a 2D or 3D environment space, according to an exemplary embodiment.

FIG. 6 is a process flow diagram illustrating a method to produce a feature encoded computer readable map, according to an exemplary embodiment.

FIG. 7 is a process flow diagram illustrating a method to utilize a feature embedded map to respond to a user query, according to an exemplary embodiment.

FIG. 8(i-ii) depict a feature embedded map produced by a robot being utilized to localize the robot at start-up and/or correct its mapping errors, according to an exemplary embodiment.

All Figures disclosed herein are © Copyright 2025 Brain Corporation. All rights reserved.

### DETAILED DESCRIPTION

Various aspects of the novel systems, apparatuses, and methods disclosed herein are described more fully hereinafter with reference to the accompanying drawings. This disclosure can, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art would appreciate that the scope of the disclosure is intended to cover any aspect of the novel systems, apparatuses, and methods disclosed herein, whether implemented independently of, or combined with, any other aspect of the disclosure. For example, an apparatus may be implemented or a method may be practiced using any number of the aspects set forth herein. In addition, the scope of the disclosure is intended to cover such an apparatus or method that is practiced using other structure, functionality, or structure and functionality in addition to or other than the various aspects of the disclosure set forth herein. It should be understood that any aspect disclosed herein may be implemented by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, and/or objectives. The detailed description and drawings are merely illustrative of the disclosure rather than limiting, the scope of the disclosure being defined by the appended claims and equivalents thereof.

The present disclosure provides for systems and methods for embedding feature data in computer readable maps for improved control and insight generation. As used herein, a robot may include mechanical and/or virtual entities, such as simulations of robotic motions, configured to carry out a complex series of tasks or actions autonomously. In some exemplary embodiments, robots may be machines that are guided and/or instructed by computer programs and/or electronic circuitry. In some exemplary embodiments, robots may include electro-mechanical components that are configured for navigation, where the robot may move from one location to another. Such robots may include autonomous and/or semi-autonomous cars, floor cleaners, rovers, drones, planes, boats, carts, trams, wheelchairs, industrial equipment, stocking machines, mobile platforms, personal transportation devices (e.g., hover boards, SEGWAYS®, etc.), stocking machines, trailer movers, vehicles, and the like. Robots may also include any autonomous and/or semi-autonomous machine for transporting items, people, animals, cargo, freight, objects, luggage, and/or anything desirable from one location to another.

As used herein, network interfaces may include any signal, data, or software interface with a component, network, or process including, without limitation, those of the FireWire (e.g., FW400, FW800, FWS800T, FWS1600, FWS3200, etc.), universal serial bus (“USB”) (e.g., USB 1.X, USB 2.0, USB 3.0, USB Type-C, etc.), Ethernet (e.g., 10/100, 10/100/1000 (Gigabit Ethernet), 10-Gig-E, etc.), multimedia over coax alliance technology (“MoCA”), Coaxsys (e.g., TVNET™), radio frequency tuner (e.g., in-band or OOB, cable modem, etc.), Wi-Fi (802.11), WiMAX (e.g., WiMAX (802.16)), PAN (e.g., PAN/802.15), cellular (e.g., 3G, 4G, or 5G including LTE/LTE-A/TD-LTE/TD-LTE, GSM, etc. variants thereof), IrDA families, etc. As used herein, Wi-Fi may include one or more of IEEE-Std. 802.11, variants of IEEE-Std. 802.11, standards related to IEEE-Std. 802.11 (e.g., 802.11 a/b/g/n/ac/ad/af/ah/ai/aj/aq/ax/ay), and/or other wireless standards.

As used herein, processor, microprocessor, and/or digital processor may include any type of digital processing device such as, without limitation, digital signal processors (“DSPs”), reduced instruction set computers (“RISC”), complex instruction set computers (“CISC”) processors, microprocessors, gate arrays (e.g., field programmable gate arrays (“FPGAs”)), programmable logic device (“PLDs”), reconfigurable computer fabrics (“RCFs”), array processors, secure microprocessors, and application-specific integrated circuits (“ASICs”). Such digital processors may be contained on a single unitary integrated circuit die or distributed across multiple components.

As used herein, computer program and/or software may include any sequence or human or machine cognizable steps which perform a function. Such computer program and/or software may be rendered in any programming language or environment including, for example, C/C++, C#, Fortran, COBOL, MATLAB™, PASCAL, GO, RUST, SCALA, Python, assembly language, markup languages (e.g., HTML, SGML, XML, VoXML), and the like, as well as object-oriented environments such as the Common Object Request Broker Architecture (“CORBA”), JAVA™ (including J2ME, Java Beans, etc.), Binary Runtime Environment (e.g., “BREW”), and the like.

As used herein, connection, link, and/or wireless link may include a causal link between any two or more entities (whether physical or logical/virtual), which enables information exchange between the entities.

As used herein, computer and/or computing device may include, but are not limited to, personal computers (“PCs”) and minicomputers, whether desktop, laptop, or otherwise, mainframe computers, workstations, servers, personal digital assistants (“PDAs”), handheld computers, embedded computers, programmable logic devices, personal communicators, tablet computers, mobile devices, portable navigation aids, J2ME equipped devices, cellular telephones, smart phones, personal integrated communication or entertainment devices, and/or any other device capable of executing a set of instructions and processing an incoming data signal.

Detailed descriptions of the various embodiments of the system and methods of the disclosure are now provided. While many examples discussed herein may refer to specific exemplary embodiments, it will be appreciated that the described systems and methods contained herein are applicable to any kind of robot. Myriad other embodiments or uses for the technology described herein would be readily envisaged by those having ordinary skill in the art, given the contents of the present disclosure.

Advantageously, the systems and methods of this disclosure at least: (i) enhance the information within a computer readable map produced by a robot; (ii) enable natural language prompts to command a robot; and (iii) enable natural language prompts to query computer readable maps from robots for insights. Other advantages are readily discernable by one having ordinary skill in the art given the contents of the present disclosure.

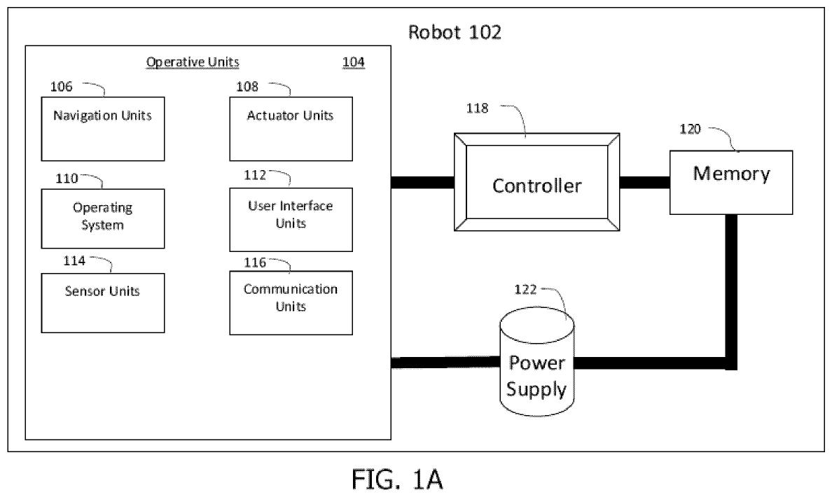

FIG. 1A is a functional block diagram of a robot 102 in accordance with some principles of this disclosure. As illustrated in FIG. 1A, robot 102 may include controller 118, memory 120, user interface unit 112, sensor units 114, navigation units 106, actuator unit 108, and communications unit 116, as well as other components and subcomponents (e.g., some of which may not be illustrated). Although a specific embodiment is illustrated in FIG. 1A, it is appreciated that the architecture may be varied in certain embodiments as would be readily apparent to one of ordinary skill given the contents of the present disclosure. As used herein, robot 102 may be representative at least in part of any robot described in this disclosure.

Controller 118 may control the various operations performed by robot 102. Controller 118 may include and/or comprise one or more processing devices (e.g., microprocessing devices) and other peripherals. As previously mentioned and used herein, processing device, microprocessing device, and/or digital processing device may include any type of digital processing device such as, without limitation, digital signal processing devices (“DSPs”), reduced instruction set computers (“RISC”), complex instruction set computers (“CISC”), microprocessing devices, gate arrays (e.g., field programmable gate arrays (“FPGAs”)), programmable logic device (“PLDs”), reconfigurable computer fabrics (“RCFs”), array processing devices, secure microprocessing devices and application-specific integrated circuits (“ASICs”). Peripherals may include hardware accelerators configured to perform a specific function using hardware elements such as, without limitation, encryption/description hardware, algebraic processing devices (e.g., tensor processing units, quadradic problem solvers, multipliers, etc.), data compressors, encoders, arithmetic logic units (“ALU”), and the like. Such digital processing devices may be contained on a single unitary integrated circuit die, or distributed across multiple components.

Controller 118 may be operatively and/or communicatively coupled to memory 120. Memory 120 may include any type of integrated circuit or other storage device configured to store digital data including, without limitation, read-only memory (“ROM”), random access memory (“RAM”), non-volatile random access memory (“NVRAM”), programmable read-only memory (“PROM”), electrically erasable programmable read-only memory (“EEPROM”), dynamic random-access memory (“DRAM”), Mobile DRAM, synchronous DRAM (“SDRAM”), double data rate SDRAM (“DDR/2 SDRAM”), extended data output (“EDO”) RAM, fast page mode RAM (“FPM”), reduced latency DRAM (“RLDRAM”), static RAM (“SRAM”), flash memory (e.g., NAND/NOR), memristor memory, pseudostatic RAM (“PSRAM”), etc.

Memory 120 may provide computer-readable instructions and data to controller 118. For example, memory 120 may be a non-transitory, computer-readable storage apparatus and/or medium having a plurality of instructions stored thereon, the instructions being executable by a processing apparatus (e.g., controller 118) to operate robot 102. In some cases, the computer-readable instructions may be configured to, when executed by the processing apparatus, cause the processing apparatus to perform the various methods, features, and/or functionality described in this disclosure. Accordingly, controller 118 may perform logical and/or arithmetic operations based on program instructions stored within memory 120. In some cases, the instructions and/or data of memory 120 may be stored in a combination of hardware, some located locally within robot 102, and some located remote from robot 102 (e.g., in a cloud, server, network, etc.).

It should be readily apparent to one of ordinary skill in the art that a processing device may be internal to or onboard robot 102 and/or may be external to robot 102 and be communicatively coupled to controller 118 of robot 102 utilizing communication units 116 wherein the external processing device may receive data from robot 102, process the data, and transmit computer-readable instructions back to controller 118. In at least one non-limiting exemplary embodiment, the processing device may be on a remote server (not shown).

In some exemplary embodiments, memory 120, shown in FIG. 1A, may store a library of sensor data. In some cases, the sensor data may be associated at least in part with objects and/or people. In exemplary embodiments, this library may include sensor data related to objects and/or people in different conditions, such as sensor data related to objects and/or people with different compositions (e.g., materials, reflective properties, molecular makeup, etc.), different lighting conditions, angles, sizes, distances, clarity (e.g., blurred, obstructed/occluded, partially off frame, etc.), colors, surroundings, and/or other conditions. The sensor data in the library may be taken by a sensor (e.g., a sensor of sensor units 114 or any other sensor) and/or generated automatically, such as with a computer program that is configured to generate/simulate (e.g., in a virtual world) library sensor data (e.g., which may generate/simulate these library data entirely digitally and/or beginning from actual sensor data) from different lighting conditions, angles, sizes, distances, clarity (e.g., blurred, obstructed/occluded, partially off frame, etc.), colors, surroundings, and/or other conditions. The number of images in the library may depend at least in part on one or more of the amount of available data, the variability of the surrounding environment in which robot 102 operates, the complexity of objects and/or people, the variability in appearance of objects, physical properties of robots, the characteristics of the sensors, and/or the amount of available storage space (e.g., in the library, memory 120, and/or local or remote storage). In exemplary embodiments, at least a portion of the library may be stored on a network (e.g., cloud, server, distributed network, etc.) and/or may not be stored completely within memory 120. As yet another exemplary embodiment, various robots (e.g., that are commonly associated, such as robots by a common manufacturer, user, network, etc.) may be networked so that data captured by individual robots are collectively shared with other robots. In such a fashion, these robots may be configured to learn and/or share sensor data in order to facilitate the ability to readily detect and/or identify errors and/or assist events.

Still referring to FIG. 1A, operative units 104 may be coupled to controller 118, or any other controller, to perform the various operations described in this disclosure. One, more, or none of the modules in operative units 104 may be included in some embodiments. Throughout this disclosure, reference may be to various controllers and/or processing devices. In some embodiments, a single controller (e.g., controller 118) may serve as the various controllers and/or processing devices described. In other embodiments different controllers and/or processing devices may be used, such as controllers and/or processing devices used particularly for one or more operative units 104. Controller 118 may send and/or receive signals, such as power signals, status signals, data signals, electrical signals, and/or any other desirable signals, including discrete and analog signals to operative units 104. Controller 118 may coordinate and/or manage operative units 104, and/or set timings (e.g., synchronously or asynchronously), turn off/on control power, receive/send network instructions and/or updates, update firmware, send interrogatory signals, receive and/or send statuses, and/or perform any operations for running features of robot 102.

Operative units 104 in FIG. 1A may include various units that perform functions for robot 102. For example, operative units 104 includes at least navigation units 106, actuator units 108, user interface units 112, sensor units 114, and communication units 116. Operative units 104 may also comprise other units such as specifically configured task units (not shown) that provide the various functionality of robot 102. In exemplary embodiments, operative units 104 may be instantiated in software, hardware, or both software and hardware. For example, in some cases, units of operative units 104 may comprise computer implemented instructions executed by a controller. In exemplary embodiments, units of operative unit 104 may comprise hardcoded logic (e.g., ASICS). In exemplary embodiments, units of operative units 104 may comprise both computer-implemented instructions executed by a controller and hardcoded logic. Where operative units 104 are implemented in part in software, operative units 104 may include units/modules of code configured to provide one or more functionalities.

In exemplary embodiments, navigation units 106 may include systems and methods that may computationally construct and update a map of an environment, localize robot 102 (e.g., find the position) in a map, and navigate robot 102 to/from destinations. The mapping may be performed by imposing data obtained in part by sensor units 114 into a computer-readable map representative at least in part of the environment. In exemplary embodiments, a map of an environment may be uploaded to robot 102 through user interface units 112, uploaded wirelessly or through wired connection, or taught to robot 102 by a user.

In exemplary embodiments, navigation units 106 may include components and/or software configured to provide directional instructions for robot 102 to navigate. Navigation units 106 may process maps, routes, and localization information generated by mapping and localization units, data from sensor units 114, and/or other operative units 104.

Still referring to FIG. 1A, actuator units 108 may include actuators such as electric motors, gas motors, driven magnet systems, solenoid/ratchet systems, piezoelectric systems (e.g., inchworm motors), magneto strictive elements, gesticulation, and/or any way of driving an actuator known in the art. By way of illustration, such actuators may actuate the wheels for robot 102 to navigate a route; navigate around obstacles; rotate cameras and sensors. According to exemplary embodiments, actuator unit 108 may include systems that allow movement of robot 102, such as motorize propulsion. For example, motorized propulsion may move robot 102 in a forward or backward direction, and/or be used at least in part in turning the robot 102 (e.g., left, right, and/or any other direction). By way of illustration, actuator unit 108 may control if robot 102 is moving or is stopped and/or allow robot 102 to navigate from one location to another location.

Actuator unit 108 may also include any system used for actuating and, in some cases actuating task units to perform tasks. For example, actuator unit 108 may include driven magnet systems, motors/engines (e.g., electric motors, combustion engines, steam engines, and/or any type of motor/engine known in the art), solenoid/ratchet system, piezoelectric system (e.g., an inchworm motor), magnetostrictive elements, gesticulation, and/or any actuator known in the art.

According to exemplary embodiments, sensor units 114 may comprise systems and/or methods that may detect characteristics within and/or around robot 102. Sensor units 114 may comprise a plurality and/or a combination of sensors. Sensor units 114 may include sensors that are internal or external to robot 102, and/or have components that are partially internal and/or partially external. In some cases, sensor units 114 may include one or more exteroceptive sensors, such as sonars, light detection and ranging (“LiDAR”) sensors, radars, lasers, cameras (including video cameras (e.g., red-blue-green (“RBG”) cameras, infrared cameras, three-dimensional (“3D”) cameras, thermal cameras, etc.), time of flight (“ToF”) cameras, structured light cameras, etc.), antennas, motion detectors, microphones, and/or any other sensor known in the art. According to some exemplary embodiments, sensor units 114 may collect raw measurements (e.g., currents, voltages, resistances, gate logic, etc.) and/or transformed measurements (e.g., distances, angles, detected points in obstacles, etc.). In some cases, measurements may be aggregated and/or summarized. Sensor units 114 may generate data based at least in part on distance or height measurements. Such data may be stored in data structures, such as matrices, arrays, queues, lists, arrays, stacks, bags, etc.

According to exemplary embodiments, sensor units 114 may include sensors that may measure internal characteristics of robot 102. For example, sensor units 114 may measure temperature, power levels, statuses, and/or any characteristic of robot 102. In some cases, sensor units 114 may be configured to determine the odometry of robot 102. For example, sensor units 114 may include proprioceptive sensors, which may comprise sensors such as accelerometers, inertial measurement units (“IMU”), odometers, gyroscopes, speedometers, cameras (e.g. using visual odometry), clock/timer, and the like. Odometry may facilitate autonomous navigation and/or autonomous actions of robot 102. This odometry may include robot 102's position (e.g., where position may include robot's location, displacement and/or orientation, and may sometimes be interchangeable with the term pose as used herein) relative to the initial location. Such data may be stored in data structures, such as matrices, arrays, queues, lists, arrays, stacks, bags, etc. According to exemplary embodiments, the data structure of the sensor data may be called an image.

According to exemplary embodiments, sensor units 114 may be in part external to the robot 102 and coupled to communications units 116. For example, a security camera within an environment of a robot 102 may provide a controller 118 of the robot 102 with a video feed via wired or wireless communication channel(s). In some instances, sensor units 114 may include sensors configured to detect a presence of an object at a location such as, for example without limitation, a pressure or motion sensor may be disposed at a shopping cart storage location of a grocery store, wherein the controller 118 of the robot 102 may utilize data from the pressure or motion sensor to determine if the robot 102 should retrieve more shopping carts for customers.

According to exemplary embodiments, user interface units 112 may be configured to enable a user to interact with robot 102. For example, user interface units 112 may include touch panels, buttons, keypads/keyboards, ports (e.g., universal serial bus (“USB”), digital visual interface (“DVI”), Display Port, E-Sata, Firewire, PS/2, Serial, VGA, SCSI, audioport, high-definition multimedia interface (“HDMI”), personal computer memory card international association (“PCMCIA”) ports, memory card ports (e.g., secure digital (“SD”) and miniSD), and/or ports for computer-readable medium), mice, rollerballs, consoles, vibrators, audio transducers, and/or any interface for a user to input and/or receive data and/or commands, whether coupled wirelessly or through wires. Users may interact through voice commands or gestures. User interface units 218 may include a display, such as, without limitation, liquid crystal display (“LCDs”), light-emitting diode (“LED”) displays, LED LCD displays, in-plane-switching (“IPS”) displays, cathode ray tubes, plasma displays, high definition (“HD”) panels, 4K displays, retina displays, organic LED displays, touchscreens, surfaces, canvases, and/or any displays, televisions, monitors, panels, and/or devices known in the art for visual presentation. According to exemplary embodiments user interface units 112 may be positioned on the body of robot 102. According to exemplary embodiments, user interface units 112 may be positioned away from the body of robot 102 but may be communicatively coupled to robot 102 (e.g., via communication units including transmitters, receivers, and/or transceivers) directly or indirectly (e.g., through a network, server, and/or a cloud). According to exemplary embodiments, user interface units 112 may include one or more projections of images on a surface (e.g., the floor) proximally located to the robot, e.g., to provide information to the occupant or to people around the robot. The information could be the direction of future movement of the robot, such as an indication of moving forward, left, right, back, at an angle, and/or any other direction. In some cases, such information may utilize arrows, colors, symbols, etc.

According to exemplary embodiments, communications unit 116 may include one or more receivers, transmitters, and/or transceivers. Communications unit 116 may be configured to send/receive a transmission protocol, such as BLUETOOTH®, ZIGBEE®, Wi-Fi, induction wireless data transmission, radio frequencies, radio transmission, radio-frequency identification (“RFID”), near-field communication (“NFC”), infrared, network interfaces, cellular technologies such as 3G (3.5G, 3.75G, 3GPP/3GPP2/HSPA+), 4G (4GPP/4GPP2/LTE/LTE-TDD/LTE-FDD), 5G (5GPP/5GPP2), or 5G LTE (long-term evolution, and variants thereof including LTE-A, LTE-U, LTE-A Pro, etc.), high-speed downlink packet access (“HSDPA”), high-speed uplink packet access (“HSUPA”), time division multiple access (“TDMA”), code division multiple access (“CDMA”) (e.g., IS-95A, wideband code division multiple access (“WCDMA”), etc.), frequency hopping spread spectrum (“FHSS”), direct sequence spread spectrum (“DSSS”), global system for mobile communication (“GSM”), Personal Area Network (“PAN”) (e.g., PAN/802.15), worldwide interoperability for microwave access (“WiMAX”), 802.20, long term evolution (“LTE”) (e.g., LTE/LTE-A), time division LTE (“TD-LTE”), global system for mobile communication (“GSM”), narrowband/frequency-division multiple access (“FDMA”), orthogonal frequency-division multiplexing (“OFDM”), analog cellular, cellular digital packet data (“CDPD”), satellite systems, millimeter wave or microwave systems, acoustic, infrared (e.g., infrared data association (“IrDA”)), and/or any other form of wireless data transmission.

Communications unit 116 may also be configured to send/receive signals utilizing a transmission protocol over wired connections, such as any cable that has a signal line and ground. For example, such cables may include Ethernet cables, coaxial cables, Universal Serial Bus (“USB”), Fire Wire, and/or any connection known in the art. Such protocols may be used by communications unit 116 to communicate to external systems, such as computers, smart phones, tablets, data capture systems, mobile telecommunications networks, clouds, servers, or the like. Communications unit 116 may be configured to send and receive signals comprising of numbers, letters, alphanumeric characters, and/or symbols. In some cases, signals may be encrypted, using algorithms such as 128-bit or 256-bit keys and/or other encryption algorithms complying with standards such as the Advanced Encryption Standard (“AES”), RSA, Data Encryption Standard (“DES”), Triple DES, and the like. Communications unit 116 may be configured to send and receive statuses, commands, and other data/information. For example, communications unit 116 may communicate with a user operator to allow the user to control robot 102. Communications unit 116 may communicate with a server/network (e.g., a network) in order to allow robot 102 to send data, statuses, commands, and other communications to the server. The server may also be communicatively coupled to computer(s) and/or device(s) that may be used to monitor and/or control robot 102 remotely. Communications unit 116 may also receive updates (e.g., firmware or data updates), data, statuses, commands, and other communications from a server for robot 102.

In exemplary embodiments, operating system 110 may be configured to manage memory 120, controller 118, power supply 122, modules in operative units 104, and/or any software, hardware, and/or features of robot 102. For example, and without limitation, operating system 110 may include device drivers to manage hardware recourses for robot 102.

In exemplary embodiments, power supply 122 may include one or more batteries, including, without limitation, lithium, lithium ion, nickel-cadmium, nickel-metal hydride, nickel-hydrogen, carbon-zinc, silver-oxide, zinc-carbon, zinc-air, mercury oxide, alkaline, or any other type of battery known in the art. Certain batteries may be rechargeable, such as wirelessly (e.g., by resonant circuit and/or a resonant tank circuit) and/or plugging into an external power source. Power supply 122 may also be any supplier of energy, including wall sockets and electronic devices that convert solar, wind, water, nuclear, hydrogen, gasoline, natural gas, fossil fuels, mechanical energy, steam, and/or any power source into electricity.

One or more of the units described with respect to FIG. 1A (including memory 120, controller 118, sensor units 114, user interface unit 112, actuator unit 108, communications unit 116, mapping and localization unit 126, and/or other units) may be integrated onto robot 102, such as in an integrated system. However, according to some exemplary embodiments, one or more of these units may be part of an attachable module. This module may be attached to an existing apparatus to automate so that it behaves as a robot. Accordingly, the features described in this disclosure with reference to robot 102 may be instantiated in a module that may be attached to an existing apparatus and/or integrated onto robot 102 in an integrated system. Moreover, in some cases, a person having ordinary skill in the art would appreciate from the contents of this disclosure that at least a portion of the features described in this disclosure may also be run remotely, such as in a cloud, network, and/or server.

As used herein, a robot 102, a controller 118, or any other controller, processing device, or robot performing a task, operation or transformation illustrated in the figures below comprises a controller executing computer readable instructions stored on a non-transitory computer readable storage apparatus, such as memory 120, as would be appreciated by one skilled in the art.

Next referring to FIG. 1B, the architecture of a processor or processing device 138 is illustrated according to an exemplary embodiment. As illustrated in FIG. 1B, the processing device 138 includes a data bus 128, a receiver 126, a transmitter 134, at least one processor 130, and a memory 132. The receiver 126, the processor 130 and the transmitter 134 all communicate with each other via the data bus 128. The processor 130 is configurable to access the memory 132 which stores computer code or computer readable instructions in order for the processor 130 to execute the specialized algorithms. As illustrated in FIG. 1B, memory 132 may comprise some, none, different, or all of the features of memory 120 previously illustrated in FIG. 1A. The algorithms executed by the processor 130 are discussed in further detail below. The receiver 126 as shown in FIG. 1B is configurable to receive input signals 124. The input signals 124 may comprise signals from a plurality of operative units 104 illustrated in FIG. 1A including, but not limited to, sensor data from sensor units 114, user inputs, motor feedback, external communication signals (e.g., from a remote server), and/or any other signal from an operative unit 104 requiring further processing. The receiver 126 communicates these received signals to the processor 130 via the data bus 128. As one skilled in the art would appreciate, the data bus 128 is the means of communication between the different components-receiver, processor, and transmitter—in the processing device. The processor 130 executes the algorithms, as discussed below, by accessing specialized computer-readable instructions from the memory 132. Further detailed description as to the processor 130 executing the specialized algorithms in receiving, processing and transmitting of these signals is discussed above with respect to FIG. 1A. The memory 132 is a storage medium for storing computer code or instructions. The storage medium may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage medium may include volatile, nonvolatile, dynamic, static, read/write, read-only, random-access, sequential-access, location-addressable, file-addressable, and/or content-addressable devices. The processor 130 may communicate output signals to transmitter 134 via data bus 128 as illustrated. The transmitter 134 may be configurable to further communicate the output signals to a plurality of operative units 104 illustrated by signal output 136.

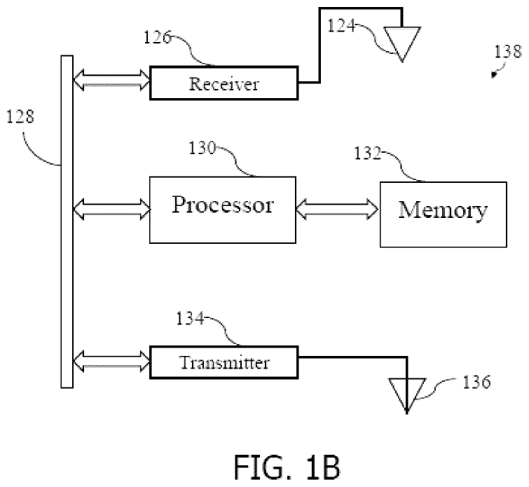

One of ordinary skill in the art would appreciate that the architecture illustrated in FIG. 1B may illustrate an external server architecture configurable to effectuate the control of a robotic apparatus from a remote location, such as server 202 illustrated next in FIG. 2. That is, the server may also include a data bus, a receiver, a transmitter, a processor, and a memory that stores specialized computer readable instructions thereon.

One of ordinary skill in the art would appreciate that a controller 118 of a robot 102 may include one or more processing devices 138 and may further include other peripheral devices used for processing information, such as ASICS, DPS, proportional-integral-derivative (“PID”) controllers, hardware accelerators (e.g., encryption/decryption hardware), and/or other peripherals (e.g., analog to digital converters) described above in FIG. 1A. The other peripheral devices when instantiated in hardware are commonly used within the art to accelerate specific tasks (e.g., multiplication, encryption, etc.) which may alternatively be performed using the system architecture of FIG. 1B. In some instances, peripheral devices are used as a means for intercommunication between the controller 118 and operative units 104 (e.g., digital to analog converters and/or amplifiers for producing actuator signals). Accordingly, as used herein, the controller 118 executing computer readable instructions to perform a function may include one or more processing devices 138 thereof executing computer readable instructions and, in some instances, the use of any hardware peripherals known within the art. Controller 118 may be illustrative of various processing devices 138 and peripherals integrated into a single circuit die or distributed to various locations of the robot 102 which receive, process, and output information to/from operative units 104 of the robot 102 to effectuate control of the robot 102 in accordance with instructions stored in a memory 120, 132. For example, controller 118 may include a plurality of processing devices 138 for performing high level tasks (e.g., planning a route to avoid obstacles) and processing devices 138 for performing low-level tasks (e.g., producing actuator signals in accordance with the route).

FIG. 2 illustrates a neural network 200, according to an exemplary embodiment. The neural network 200 may comprise a plurality of input nodes 202, intermediate nodes 206, and output nodes 210. The input nodes 202 being connected via links 204 to one or more intermediate nodes 206. Some intermediate nodes 206 may be respectively connected via links 208 to one or more adjacent intermediate nodes 206. Some intermediate nodes 206 may be connected via links 212 to output nodes 210. Links 204, 208, 212 illustrate inputs/outputs to/from the nodes 202, 206, and 210 in accordance with equation 1 below. The intermediate nodes 206 may form an intermediate layer 214 of the neural network 200, often referred to as a hidden layer. In some embodiments, a neural network 200 may comprise a plurality of intermediate layers 214, intermediate nodes 206 of each intermediate layer 214 being linked to one or more intermediate nodes 206 of adjacent layers, unless an adjacent layer is an input layer (i.e., input nodes 202) or an output layer (i.e., output nodes 210). The two intermediate layers 214 illustrated may correspond to a hidden layer of neural network 200, however a hidden layer may comprise more or fewer intermediate layers 214 or intermediate nodes 206. Each node 202, 206, and 210 may be linked to any number of nodes, wherein linking all nodes together as illustrated is not intended to be limiting. For example, the input nodes 202 may be directly linked to one or more output nodes 210.

The input nodes 202 may receive a numeric value xᵢ of a sensory input of a feature, i being an integer index. For example, xᵢ may represent color values of an i^{th} pixel of a color image. The input nodes 202 may output the numeric value xᵢ to one or more intermediate nodes 206 via links 204. Each intermediate node 206 may be configured to receive a numeric value on its respective input link 204 and output another numeric value k_{i,j} to links 208 following the equation 1 below:

k_{i,j}=a_{i,j}x₀+b_{i,j}x₁+c_{i,j}x₂+d_{i,j}x₃ (Eqn. 1)

Index i corresponds to a node number within a layer (e.g., x₁ denotes the first input node 202 of the input layer, indexing from zero). Index j corresponds to a layer, wherein j would be equal to one for the one intermediate layer 214-1 of the neural network 200 illustrated, however, j may be any number corresponding to a neural network 200 comprising any number of intermediate layers 214. Constants a, b, c, and d represent weights to be learned in accordance with a training process. The number of constants of equation 1 may depend on a number of input links 204 to a respective intermediate node 206. In this embodiment, all intermediate nodes 206 are linked to all input nodes 202, however this is not intended to be limiting. Intermediate nodes 206 of the second (rightmost) intermediate layer 214-2 may output values k_{i,2} to respective links 212 following equation 1 above. It is appreciated that constants a, b, c, d may be of different values for each intermediate node 206. Further, although the above equation 1 utilizes addition of inputs multiplied by respective learned coefficients, other operations are applicable, such as convolution operations, thresholds for input values for producing an output, and/or biases, wherein the above equation is intended to be illustrative and non-limiting. The nodes may further include activation functions, such as rectified linear unit (“ReLU”), sigmoid, softmax, or other activation functions.

Output nodes 210 may be configured to receive at least one numeric value k_{i,j} from at least an i^{th} intermediate node 206 of a final (i.e., rightmost) intermediate layer 214. As illustrated, for example, each output node 210 receives numeric values k_{0-7,2} from the eight intermediate nodes 206 of the second intermediate layer 214-2. The output ci of the output nodes 210 may be calculated following a substantially similar equation as equation 1 above (i.e., based on learned weights and inputs from connections 212) and considering potential activation functions.

The training process comprises providing the neural network 200 with both input and output pairs of values to the input nodes 202 and output nodes 210, respectively, such that weights of the intermediate nodes 206 may be determined. An input and output pair comprise a ground truth data input comprising values for the input nodes 202 and corresponding correct values for the output nodes 210 (e.g., an image and corresponding annotations or labels). The determined weights configure the neural network 200 to receive input to input nodes 202 and determine a correct output at the output nodes 210. By way of illustrative example, annotated (i.e., labeled) images may be utilized to train a neural network 200 to identify objects or features within the image based on the annotations and the image itself, the annotations may comprise, e.g., pixels encoded with “cat” or “not cat” information if the training is intended to configure the neural network 200 to identify cats within an image. The unannotated images of the training pairs (i.e., pixel RGB color values) may be provided to input nodes 202 and the annotations of the image (i.e., classifications for each pixel) may be provided to the output nodes 210, wherein weights of the intermediate nodes 206 may be adjusted such that the neural network 200 generates the annotations of the image based on the provided pixel color values to the input nodes 202. This process may be repeated using a substantial number of labeled images (e.g., hundreds or more) such that ideal weights of each intermediate node 206 may be determined. Such a process may be effectuated via backpropagation algorithms. The training process is complete upon predictions made by the neural network 200 falls below a threshold error rate which may be defined using a cost function.

As used herein, a training pair may comprise any set of information provided to input and output of the neural network 200 for use in training the neural network 200. For example, a training pair may comprise an image and one or more labels of the image (e.g., an image depicting a cat and a bounding box associated with a region occupied by the cat within he image).

Neural network 200 may be configured to receive any set of numeric values representative of any feature and provide an output set of numeric values representative of the feature. For example, the inputs may comprise color values of a color image and outputs may comprise classifications for each pixel of the image, which may be encoded as Boolean or floating point values. As another example, inputs may comprise numeric values for a time dependent trend of a parameter (e.g., temperature fluctuations within a building measured by a sensor) and output nodes 210 may provide a predicted value for the parameter at a future time based on the observed trends, wherein the trends may be utilized to train the neural network 200. Training of the neural network 200 may comprise providing the neural network 200 with a sufficiently large number of training input/output pairs comprising ground truth (i.e., highly accurate) training data. As a third example, audio information may be provided to input nodes 202 and a meaning of the audio information may be provided to output nodes 210 to train the neural network 200 to identify words and speech patterns.

Generation of the sufficiently large number of input/output training pairs may be difficult and/or costly to produce. Accordingly, most contemporary neural networks 200 are configured to perform a certain task (e.g., classify a certain type of object within an image) based on training pairs provided, wherein the neural networks 200 may fail at other tasks due to a lack of sufficient training data and other computational factors (e.g., processing power). For example, a neural network 200 may be trained to identify cereal boxes within images, however the same neural network 200 may fail to identify soap bars within the images.

For deployment on mobile robots 102 with limited computational resources, the image encoder 310 and text encoder 306 are optimized for inference speed. The controller 118 may implement quantization techniques to reduce the precision of weights in the neural network 200 from floating-point to integer representations, decreasing memory bandwidth and processing latency. Additionally, the controller 118 may utilize a sliding window approach when querying the computer-readable map 402: rather than comparing the current feature embedding vector 324 against every stored vector 414 in the entire map, the controller 118 first identifies a candidate region based on odometry or last known location, then performs similarity comparisons only within that region. This reduces computational load from O(N) to O(log N) for typical operations. In large-scale environments exceeding 100,000 stored vectors, the controller 118 may build a k-dimensional tree (KD-tree) or use locality-sensitive hashing (LSH) indices to accelerate nearest-neighbor searches. These optimizations ensure that localization occurs within 100-500 milliseconds on embedded processors 130, enabling real-time autonomous navigation without perceptible delay. The memory 120 requirements are also managed by storing feature embedding vectors 414 as compact 128-dimensional or 512-dimensional tensors, balancing representational capacity against storage constraints.

As used herein, a model may comprise of the weights of intermediate nodes 206 and output nodes 210 learned during a training process. The model may be analogous to a neural network 200 with fixed weights (e.g., constants a, b, c, d of equation 1) and fixed connection efficacies, wherein the values of the fixed weights are learned during the training process. A trained model, as used herein, may include any mathematical model derived based on a training of a neural network 200. One skilled in the art may appreciate that utilizing a model from a trained neural network 200 to perform a function (e.g., identify a feature within sensor data from a robot 102) utilizes significantly less computational recourses than training of the neural network 200 as the values of the weights are fixed. This is analogous to using a predetermined equation to solve a problem as compared to determining the equation itself based on a set of inputs and results.

According to at least one non-limiting exemplary embodiment, one or more outputs k_{i,j} from intermediate nodes 206 of a j^{th} intermediate layer 212 may be utilized as inputs to one or more intermediate nodes 206 an m^{th} intermediate layer 212, wherein index m may be greater than or less than j (e.g., a recurrent or feed forward neural network). According to at least one non-limiting exemplary embodiment, a neural network 200 may comprise N dimensions for an N dimensional feature (e.g., a 2-dimensional input image or point cloud), wherein only one dimension has been illustrated for clarity. One skilled in the art may appreciate a plurality of other embodiments of a neural network 200, wherein the neural network 200 illustrated represents a simplified embodiment of a neural network to illustrate the structure, utility, and training of neural networks and is not intended to be limiting. The exact configuration of the neural network used may depend on (i) processing resources available, (ii) training data available, (iii) quality of the training data, and/or (iv) difficulty or complexity of the classification/problem. Further, programs such as AutoKeras, utilize automatic machine learning (“AutoML”) to enable one of ordinary skill in the art to optimize a neural network 200 design to a specified task or data set.

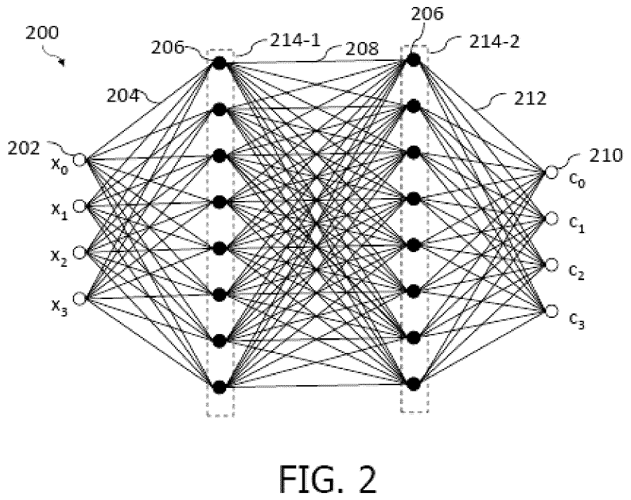

FIG. 3A is a diagram illustrating a model being configured to identify a correspondence between natural language text and imaged representations thereof, according to an exemplary embodiment. Correspondence, as used herein, occurs when two or more data elements of the same or different modalities, such as images, text, videos, or other data structures, comprise a same or substantially identical feature represented in the different modalities (e.g., an image of a truck and the word “truck” correspond). The training data in this embodiment comprises of two data sets: first data set 302 and second data set 304 as shown in FIG. 3A. These data sets may be obtained by one or more sensory units 114, obtained from a server, or provided by a user.

First data set 302 comprises a plurality of linguistic prompts, wherein each of the plurality of linguistic prompts describe respective features therein. Each of the respective features in the plurality of linguistic prompts correspond to an image in the second data set 304 that comprises a plurality of images. For instance, a respective prompt in the first data set 302 may comprise of “a brown cat” and the corresponding respective image of the plurality of images in the second data set 304 may comprise of a brown cat. Thereby, associating the respective feature in a respective linguistic prompt in the first data set 302 to a respective image in the second data set 304. Stated differently, the prompt in first data 302 includes a feature and the image in second data set 304 depicts said feature. Preferably the semantic structure of these linguistic prompts are short, objective, and convey only the relevant feature information (e.g., colors such as brown, or objects such as cat). Other semantic structures such as natural language may be utilized without limitation, provide additional semantics, such as headings, transition phrases, etc., or subjective terms may add noise to the system during training, thereby increasing the difficulty in training a text encoder 306 to output proper text to image correspondences. Pre-filtering of the input query may be implemented, such as drop-down menus which limit the query breadth to discrete categories of features the model is trained to recognize.

Next, the first data set 302 is received by a text encoder 306 which embodies a plurality of nodes and weighted connections, as shown in FIG. 2 for example. The text encoder 306 may transform the input string of the first data set 302 into a plurality of vectors 308 based on the weights and connection efficacies of the model. Each vector Tn represents a vector output from the text encoder 306 for the n^{th} text string. Each of the N total elements in the first data set 302 produce a corresponding vector 308. For example, if the first data set 302 comprised of ten (10) linguistic prompts, each of the linguistic prompts when provided to the encoder 306 produce a respective vector (T₁, T₂, T₃ . . . . T₁₀). And each respective feature in the respective linguistic prompt is represented in the respective vector.

In a similar manner, the second data set 304, which comprises a plurality of images, is provided to an image encoder 310, which is different from the text encoder 306. The image encoder 310 embodies a model comprising a plurality of nodes and weighted connections similar to the text encoder 306 or network shown in FIG. 2. The image encoder 310 vectorizes the images 304 in a similar manner to the text encoder 306 to produce feature vectors Iₙ. That is, the input of plurality of images in the second data set 304 are each received by a plurality of input nodes 202 of the image encoder 310. Upon receipt, the image encoder 310, according to a configuration of weights as described in FIG. 2 above, produces a plurality of feature vector outputs 312 via nodes 210. The vector outputs 312 are represented as Iₘ corresponding to the vector output for the m^{th} image. For example, if the second data set 304 comprised of ten (10) images, each of the images will have a respective vector (I₁, I₂, I₃ . . . . I₁₀). These individual output values will be referred to herein as the “feature vector” 312 for a respective input images to the image encoder 310.

Based on the output from text encoder 306 and image encoder 310, training pairs of the respective image and text (i.e., image (Iₘ), text (Tₙ)) are configured such that the n^{th} text corresponds to the m^{th} image, wherein n and m are arbitrary integers greater than or equal to one (1). These two series of vectors 308, 312 from the respective two encoders 306, 310 may be utilized to produce a similarity matrix 314, as shown in FIG. 3A, which helps in training the correspondences in the encoder 306, 310 weights. In this instance, at least the diagonal of the similarity matrix should indicate strong correspondence for any IₘTₙ pair, where m=n. The similarity matrix 314 may be N by M, wherein N and M are integers greater than or equal to one (1) corresponding to the total number of feature vectors in the feature vector outputs 308 and 312. The cells of the similarity matrix may comprise values equal to the dot product or cosine similarity of the two vectors IₘTₙ.

According to at least one non-limiting exemplary embodiment, the training may utilize a plurality of images in the second data set 304 for determining feature(s) in a linguistic prompt of the first data set 302. In some non-limiting exemplary embodiments, the converse may be utilized wherein a plurality of linguistic prompts in the first data set 302 are provided for a single image in the second data set 304. In these cases, the similarity matrix 314 would contain additional cells with high correspondence values which may not run diagonally across the matrix 314.

If the neural network model of FIG. 2 used by the encoders 306 and 310 are properly configured, then the similarity matrix 314 should indicate strong correspondences between training (image, text) pairs, wherein the weighting of the models may be changed to achieve the desired (image, text) prediction accuracy. Upon reiterative training of the models, a given input text string or linguistic prompt from first data set 302 should result in the text encoder 306 producing a feature vector 308 which substantially corresponds to the respective images of the second data set 304 represented in the vector 312 produced by the image encoder 310. That is, by the correspondences of the similarity matrix 314 may be utilized to back propagate to the two encoders 306, 310 such that their weights may be adjusted to fit both input data sets 302, 304 and the output similarity matrix 314. Such reiterative process in training the model of FIG. 2 will result in a substantially close match between the linguistic prompts describing respective features therein from first data 302 and respective images from the plurality of images in the second data set 304.

The system may be considered properly trained when, via use of a validation portion of the data sets 302, 304, proper correspondences are determined at an above threshold rate (typically 90% or higher). A validation portion of the data sets corresponds to a select portion of the image data set 304 and text data set 302 used to validate the system. These portions comprise input pairs known to either correspond or not correspond, wherein the known correspondences may be compared to the matrix 314 to determine if the system is sufficiently trained. Proper correspondences, as used herein, refer to an image corresponding to a string of text which describes the image accurately. In the system shown in FIG. 3A, proper correspondences may be determined by, without limitation, diagonals of the matrix 314 indicating high correspondence (i.e., values near 1 or zero) or individual elements of the validation portion of the data sets 302, 304 producing similar feature embedding vectors 308, 312. In other words, a portion of the two data sets 302, 304 contain image and text strings which are known to correspond and utilized as test cases to determine the accuracy of the system. When provided to the two encoders 306, 310, both encoders should indicate strong correspondence where appropriate if they are properly trained.

Presuming now the system has been sufficiently trained to accurately identify corresponding text and image pairs, the two encoders 306, 310 are implemented in FIG. 3B which depicts a diagram illustrating the utilization of the trained text encoders 306 and image encoders 310, as discussed under FIG. 3A, to parse a new natural language query 316 and identify one or more images which include features that correspond to the query 316, according to an exemplary embodiment. For now, the image data set 320 is presumed to be stored in a memory and the present description for FIG. 3B aims to identify the natural language prompt within one or more images of the data set 320. Particular novel use cases will be discussed in greater detail below.

First, a natural language query 316 is provided. Natural language queries may comprise of strings of text which include a prompt, question, or statement about a feature. For instance, “where is”, “please verify”, or “can you find the” would be natural language prompts about one or more objects, places, or things of interest, commonly referred to herein as features. The objective being to identify an image from a plurality of images 320 which corresponds to the text prompt 316.

According to at least one non-limiting exemplary embodiment, natural language prompts may be multiple sentences and include irrelevant information, such as pleasantries, greetings, transitional phrases, non-imageable terms (e.g., emotions), or subjective terms. These natural language prompts 316 are provided to a text pre-processor 318 which extracts the useful and relevant information from these prompts and excludes the useless or undetectable information. For instance, headers, greetings, pleasantries, and other grammatical portions of the natural language prompts are removed to instead extract the feature(s) of interest, actionable statements (e.g., where is, how many, etc.). Subjective and un-imageable terms may also be removed as these are not detectable by the computerized system (e.g., the terms ‘beautiful/happy’ may be removed from a prompt comprising “where is the beautiful/happy cat?”). The features of interest relate to feature of which the text and image encoders 306, 310 were trained to correlate. The text pre-processor 318 may rearrange the words and/or exclude words such that the input natural language string is transformed into a format more akin to the training data set. The natural language pre-processor may itself be a separate language model that is distinct from the encoder text 306.

Secondly, the preprocessed text prompt from the text pre-processor 318 is provided to the text encoder 306, which has been trained on a plurality of text and image datasets 302, 304 as discussed above in FIG. 3A. Based on the training, the text encoder 306 produces a first, singular feature encoding in the form of vector 322 corresponding to the singular prompt. Concurrently, as the text encoder is producing a vector 322, in real-time, one or a plurality of input images 320 may be provided to the trained image encoder 310. The image encoder similarly produces a second feature encoding in the form of vector 324 for each of the input images 320.

If an input image of the image set 320 depicts a feature and the same (or synonymous term) “{feature}” was identified via the text prompt 316, and presuming the system was properly trained, one or more individual output vectors 324 of the plurality of feature embedding vectors 312 generated by the image encoder 310 should match the output vector 322 from the text encoder, indicating a high correspondence between the two inputs. This similarity may be calculated via a dot product or cosine similarity being below or exceeding a threshold, respectively. In some instances, multiple output vectors 324 may correspond to the vector 322 if multiple images in the image set 320 correspond to the text prompt 316. The same process may be performed for each vector 324 of the feature vectors 312 produced by the image encoder, where the output vectors T₁ 322 is compared to each of the output vectors 324 for each image 320 via operation 326 (e.g., a subtraction or dot product) to produce an output 328 which indicate the correspondence between the given text input 316 and the given set of plurality of images 320. Since no two images will be identical to the training set, a threshold may be implemented in operation 326 to allow some deviation between any pair of vectors 322 and 324 while still concluding that they both correspond. In some embodiments, the output 328 is a binary value (i.e., 0 or 1) whereas in other implementations it is a decimal value, wherein the value being greater than a prescribed threshold indicates a strong correspondence.

It is appreciated that the natural language text string 316 and input of plurality of images 320 are not assumed to correspond to each other, unlike the training data sets 302, 304 discussed in FIG. 3A, which are specifically chosen due to their correspondences to train the system. For instance, the plurality of images 320 shown in FIG. 3B may depict a restroom and the text prompt 316 may ask to find trucks. If there is no corresponding image in the plurality of images 320, then it is therefore likely not to have a sensible output as there ae no trucks in the restroom. Thus, even if there are no images that correspond to the prompt, the system noting the lack thereof could also be potentially insightful information. In these embodiments, the output 328 may comprise, without limitation, a null value, empty list, zero, “{feature} not found”, or other message indicating that no image in the data set 320 corresponds to the text prompt 316.

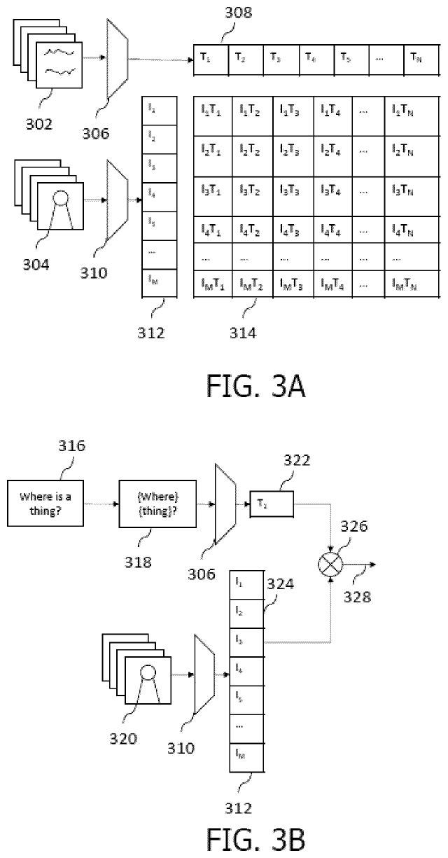

The following figures will adapt the concepts discussed in FIG. 3A-B into a practical implementation related to robotics and autonomous vehicles. Robots 102 often comprise cameras which collect a plurality of images as the robot 102 navigates, wherein the controller 118 continuously tracks the location of the robot 102 during acquisition of the images. By embedding the feature vectors 312 for images 320 captured by a robot 102 onto computer readable maps produced and used by robots 102, the information stored in the map is substantially enriched with additional feature data. This additional data encoding may enable, among other things, navigation of a robot 102 via a natural language prompt or extracting meaningful insights about the environment. For instance, instead of having to manually position the robot 102 or utilize a user interface to program the robot 102, a user may instead prompt the robot 102 to “go to the rear exit and park”. Naturally, to facilitate this task, the robot 102 needs to have knowledge of where the “rear exit” is, therefore it is required to parse the map for locations corresponding to the “rear exit”, or any other imageable exemplary feature without limitation. The system used to achieve this querying of a computer readable map will be discussed next in FIG. 4, which depicts an exemplary computer readable map 402 having feature embeddings provided thereto, according to an exemplary embodiment.

A computer readable map 402 is illustrated in FIG. 4, which comprises of a plurality of pixels. Pixels shown in different colors represent different categories or encodings. For example, black pixels correspond to objects or structures of which a robot is unable to traverse through and should avoid contact with, white pixels correspond to open space which is traversable by the robot 102, and grey pixels represents unsensed regions. In some embodiments, the map 402 and its pixel states (i.e., occupied, unsensed, or navigable) may be stored in a matrix. Some maps may contain additional state encodings without limitation or relevance to the present disclosure. Computer readable maps are often stored as a structured data element, such as a tensor representing each pixel of the map. The tensor may further include additional dimensions for encoding, for instance, object information (e.g., occupied/object or free space) for each pixel of the map. Similarly, as will be discussed herein, other information may be encoded into the tensor of the computer readable map. Stated differently, a tensor can have more dimensions beyond what might be initially apparent such that it can hold more complex information. That is, each pixel of a map can encode information about objects, such as whether a space is occupied by an object or not. This helps in understand the environment represented by the computer readable map. The tensor is not limited to just the occupied or free space data; it can also include other types of information relevant to the computer-readable map. This could potentially include various attributes related to the objects or the environment, enhancing the map's utility-including feature vectors discussed above regarding FIG. 3.

The map 402 is produced using LiDAR sensors coupled to a robot 102, which produces a plurality of ranging measurements, represented via points, on the surfaces of objects and walls of the environment. The center of the objects 404 contain grey ‘unsensed’ pixels as LiDAR beams only detect the surfaces of the objects 404. These LiDAR measurements are then projected onto the mapping plane (parallel to and, typically, at the height of the floor) to produce the map 402. Other sensor modalities and map creation methods are contemplated without limitation to the present disclosure. As the robot 102 navigates its environment to produce the map 402, it may capture a plurality of images of the environment at various locations.

Consider an exemplary pixel 406 where a robot 102 either is or was navigating while capturing an image 410. Image 410, produced below the map 402, illustrates an exit sign 412 which is above exit doors. This image 410 may be provided to the trained image encoder 310 discussed in FIGS. 3A-B above to produce a feature embedding vector 414. This feature embedding vector 414 is encoded into the corresponding map pixel 406 as a tensor, as discussed above, and will be utilized at a later time to, for instance, detect “exit signs”.

It is appreciated that the use of an exit sign is merely an arbitrary exemplary feature. It is additionally appreciated that the text “exit” of the exit sign is not provided to the text encoder 306, but rather treated the same as any other imaged feature and only provided to the image encoder 310. For instance, instead of an exit sign, the image captured by the robots 102 during navigation may only contain figures and no texts such as bathrooms, cash registers, or particular aisles/departments. Alternatively, the robot may detect other inanimate objects such as a window, air conditioning vents, or any other feature in a given environment that can be provided to the image encoder 310 for improving accuracy of the model predictions.

The trained text encoder 306 and image encoder 310, as configured through the similarity matrix 314, are deployed within the robot's controller 118 to enable real-time localization without reliance on artificial markers. When the robot 102 powers on at an arbitrary location within the physical environment, the camera 502 captures a current image that is immediately provided to the image encoder 310. The image encoder 310 processes the image through its layered nodes (202, 206, 210) and generates a feature embedding vector 324 that represents the visual characteristics of the captured scene. Concurrently, the controller 118 accesses the computer-readable map 402 stored in memory 120, which contains feature embedding vectors 414 that were previously encoded from images captured during a prior mapping traversal. Each previously stored feature embedding vector 414 is associated with specific physical location coordinates within the environment, enabling spatial referencing. The controller 118 then performs a similarity comparison operation 326 between the current feature embedding vector 324 and each stored feature embedding vector 414 in the map 402. This comparison utilizes dot product or cosine similarity calculations to determine correspondence values. When one or more stored vectors 414 yield similarity values exceeding a predetermined threshold, the controller 118 identifies those vectors as matching the current location. Based on the physical location coordinates associated with the matching vectors 414, the controller 118 determines the robot's current pose and initializes its localization estimate accordingly. This process eliminates the conventional requirement for QR codes, barcodes, beacons, charging stations, or predefined structural landmarks, as the robot can localize itself using natural visual features present in the environment. That is, rather than utilizing the prior physical devices and features as localization references, the robot 102 may instead determine its position relative to the pixel(s) comprising embedded feature vectors 414 which match the feature vector produced by an image captured at the present moment.

Notably, the location of the pixel 406 does not represent the actual location of the exit sign, but rather the location of the robot 102 during acquisition of the exit sign image 410. The actual location of the exit sign is reflected by marker 408 (shown for illustrative clarity, wherein the robot 102 does not know the true location of the exit sign). Thus, when requesting the location of the exit signs in the environment, the system should report location 408, where the exit sign physically is, and not location 406, where the robot 102 saw the exit sign from. If the robot 102 is commanded to navigate ‘to the exit sign’ it should navigate to the marker 408 and not location 406. Images captured by robots 102 may contain hundreds or even thousands of individual features, wherein predicting what features could be quarried via a prompt 316 is a daunting task, yet unnecessary given the present disclosure. Instead, the actual location of the exit sign, the doors below it, a painting on the wall, a person in the foreground, etc., specifically is/are not automatically detected or searched for unless and until a query 318 asks for it. Once a query 318 requests a specific feature to be located, such as an exit sign, the textual feature embedding produced by the text encoder 306 transforms that query into a vector 322. This vector 322 should be similar to one or more feature embedding vectors 414, discussed under FIG. 4, for one or more points on the map 402 if the feature in the query 318 is imaged by the robot 102 at the one or more respective locations. Similarity may be determined via a dot product (e.g., using normalized unit vectors, wherein the dot product is greater than a threshold of 0.8, 0.9, 0.95, etc.) or vector subtraction being below a threshold between vector 322 and vector 414. It is appreciated that the use of an exit sign feature is merely exemplary and non-limiting.

Once an above threshold similarity is detected between a vector 322, generated via the text encoder 306 from a query 318, and one or more feature embedding vectors 414 of the computer readable map 402, it may be determined that the feature in the query 318 was imaged at the location of the matching feature embedding vector 414. In other words, detecting a feature embedding vector 414 in one or more locations on the computer readable map 402 which matches the vector output 322 generated by the text encoder 306 from a query 318 indicates the robot 102 has detected a feature stated within the query 318 at the one or more locations.

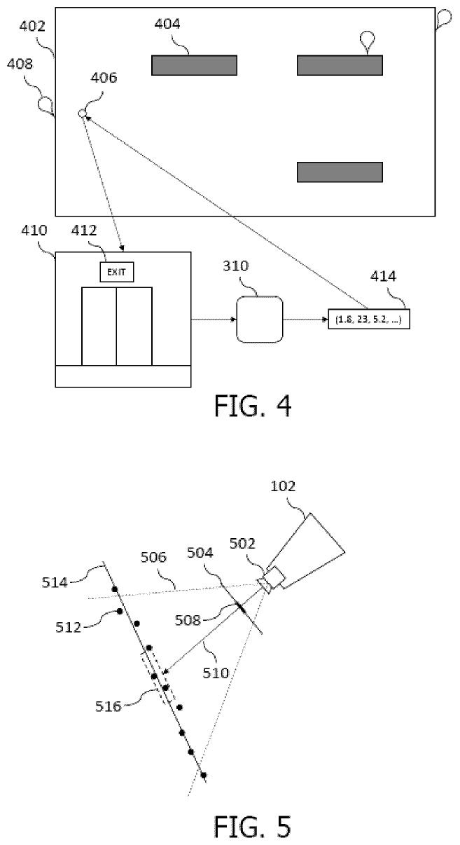

It is appreciated, however, that the location where the robot 102 detects a feature is not the actual location of the feature itself. Furthermore, robots 102 may sense a singular feature at multiple locations from various perspectives, wherein only one location feature should be detected. Accordingly, once one or more locations where the feature of interest is detected on the map 402, a projection is performed at each location to determine the true position of the feature as discussed next in FIG. 5.

As used hereinafter, the ‘pixel which has an encoded feature vector’ corresponds to the point 408, not the location of the robot during acquisition of the image, unless otherwise specified. In this example, the pixel with the encoded feature vector for the ‘exit’ feature is point 408.

Various methods for projecting a feature from an image onto a computer readable map are discussed in FIG. 5. A robot 102 with a front facing camera 502 is illustrated. The front camera 502 is configured to capture an image with a feature detected therein, according to an exemplary embodiment. Other cameras 502 placed in other position on the robot 102 are also considered without limitation in a similar manner as will be described, but are omitted for clarity. In the first method, the camera 502 captures an image with a field of view shown by dashed lines 506. An image plane 504 is shown, wherein an emboldened section 508 contains a feature to be localized onto a map. The section 508 is shown in the center of the image plane 504, however in some other instances the section 508 of the image containing feature of interest may be elsewhere in the image. The location of the feature in the image plane 504 may be determined via, for example, a bounding box or pixels encoded with feature information. Determining bounding boxes or sematic segmentation encoding may require use of a different model specifically trained to identify features in image-space locations and not the image encoder 310 discussed above which produces an embedding vector. This separate model may also be trained independently from the two encoders 306, 310 discussed in FIG. 3A.

According to a second method, from the center of the imaged feature (i.e., section 508), a ray 510 may be casted which passes from the position of the camera 502, through the section 508 of the image plane 504 with the feature and extends outward until it reaches one of the plurality of points 512. The point 512 being a ranging measurement which detects a surface, such as points detected via a LiDAR sensor. This intersection of the ray 510 from the camera 502 with a respective point 512 corresponds to the location of the feature in the overall environment traveled by the robot 102. Such location of the feature is represented by dashed lines 516. In essence, the ray 510 illustrates a projection from the image plane 504 outward into the environment until the ray 510 is incident on an opaque object detected via sensors of the robot 102, wherein the intersection of the ray 510 with the first object along its path is assumed to be the location of the feature since LiDAR nor images can see through opaque objects. In some embodiments, the ray 510 is determined as reaching a point 512 when the ray 510 is within a threshold distance to any point 512. Alternatively, instead of raw point 512 data from sensors, the ray 510 may be cast until it reaches an occupied (i.e., black) pixel, wherein that pixel is assigned to be the location of the imaged feature.

In some embodiments, the same method is used for every pixel of the bounding box or every pixel that depicts the feature rather than just the centermost pixel. That is, for each pixel determined to depict the exit sign 412 feature, a ray 510 is cast from the camera 502, through the pixel, and out into the environment until it reaches a respective point 512. Although FIG. 5 shows the projection occurring in only one image dimension (horizontally) or two spatial dimensions (x, y), this pixel-wise projection may occur in both vertical and horizontal image-space dimensions, which corresponds to three dimensions in the environmental space (i.e., height, width, depth in the image space can be translated into (x, y, z) cartesian coordinates). That is, FIG. 5 may depict a top-down view of the projection and/or a side view of the projection without limitation. This second method of projection yields a more accurate position estimate at the cost of additional processing resources.

In other embodiments, the controller 118 of the robot 102 may determine a line 514 which best approximates the position of a plurality of points 512 which surround it. For instance, the line 514 may represent a ‘best fit’ line for all points 512 within the field of view lines 506. This surface 514 may correspond to the surface which the imaged feature is projected onto. A third method may involve using a plurality of sequential images from the robot 102 captured at slightly different locations and determining depth of field therefrom. More specifically, the depth of the feature can be calculated based on its apparent motion in between two images captured at different locations (i.e., parallax motion), wherein the robot orientation, depth of field, and the image space location can be utilized to determine a 3D or 2D location of the feature. A final method may involve projecting the entire image plane 504 onto the nearest points 516 via casting a plurality of rays 510, wherein this method is the least precise yet simplest method.

In some embodiments, the location of the feature may be an area instead of a dimensionless point. For instance, instead of projecting a single ray 510, the controller 118 may instead project a plurality of rays 510 through some or all of the pixels within section 508 of the image depicting the feature, namely the two side edges of the section 508, to determine the overall area encompassed by the feature in the physical space, as shown by dashed lines 516. Pixels which fall within this area 516 are encoded with the feature data (e.g., “exit sign”).

In practical robotic deployments, occlusions frequently occur where foreground objects partially block the view of target features. To address this, the controller 118 implements an image sub-sampling methodology that enhances localization precision. The captured image 410 is divided into a grid of N×M sections (e.g., nine equal squares), where each section is treated as an independent image patch. Each patch is provided separately to the image encoder 310, which generates a distinct feature embedding vector 414 for that patch. For localization, the controller 118 compares each patch vector 414 against the stored feature embedding vectors in the map 402. Patches that contain the target feature (e.g., an exit sign 412) will produce vectors with high similarity to the query vector, while patches containing occlusions (e.g., a person standing in front of the exit) will produce low similarity scores. The controller 118 then filters out low-similarity patches and projects only the high-similarity patches onto the LiDAR point cloud using ray-casting 510. This selective projection prevents the system from erroneously mapping features onto occluding objects and improves the accuracy of the three-dimensional feature location determination. The sub-sampling approach also enables the robot to maintain localization robustness in cluttered environments where direct line-of-sight to landmarks is not consistently available.

According to at least one non-limiting exemplary embodiment, the image 410 from the robot 102 may be sub-sampled into a plurality of sections or patches of pixels, wherein each sub-section is treated as a unique image as described above. For instance, the image 410 may be divided into 9 equal squares with each square being provided to the image encoder 310 to produce a respective vector 414. This sub-dividing enables more precise localization of the features and may be useful in cases where there is an object in the foreground. Consider the image 410 depicted in FIG. 4 for example, and consider a human is standing between the camera and the exit door. If the entire image is projected as described in FIG. 5, the ‘exit’ feature may accidentally be projected (at least in part) onto LiDAR points of the person. By sub-dividing the image into sections, only the sections containing the exit sign/door 412 (and therefore producing vectors 414 having a substantial similarity to the vector Tₑₓᵢₜ produced by the prompt for an ‘exit’ feature) are projected onto the LiDAR point data improving the precision of localizing the feature. Stated another way, the image 410 shown in FIG. 4 may only comprise a portion of a larger image captured by the robot 102, wherein the section 508 represents only a portion of a larger image.

It is appreciated that this same analysis of identifying features in images and projecting them onto a 2- or 3-dimensional space may occur a plurality of times for a singular instance of a feature occurrence. As mentioned earlier, the robot 102 may navigate such that the singular feature is seen in multiple images from different perspectives and at different times. Each of these analysis may yield slightly different answers as to the precise location of the feature, however, they should all generally project the location of the feature to roughly the same place. The plurality of localization predictions for the detected feature may form a heat map, wherein the most frequent location occurrences would indicate the most likely location of the feature.

According to at least one non-limiting exemplary embodiment, the projection of the location for specific features, such as an exit sign, is performed only when the feature is queried. That is, the controller 118 may produce the feature embedding vectors 414 any or all of the images it captured at various locations. These images may, in part, contain the exit sign as well as other features such as people, trash cans, and so forth. Consider the system subsequently receiving a request to find the exit signs on the map 402 after a robot 102 has navigated the space, captured images, and a processor has utilized the images to provide feature embedding vectors 414 to the map where the images are taken. The query, e.g., “where are the exits?” is provided to the text encoder 306 to produce a vector 322. This vector 322 is compared to the feature embedding vectors 414 which are now encoded into the map 402 at various positions where the robot 102 captured images. At one or more locations on the map, the two vectors 322 (textual feature embedding) and 414 (feature embedding vectors) should be substantially similar to each other assuming the encoders 306, 310 were properly trained as discussed under FIGS. 3A-B. The substantial similarity (i.e., within threshold deviation) indicates locations where it is likely an exit sign was detected. These individual locations may be further processed to determine bounding boxes for the exit signs which may be projected into the map 402 to provide a more accurate estimate of the location of the exit signs.

Advantageously, performing the image-space to environment location projection only for queried features may reduce the amount overall processing performed on the map 402 as it is difficult to predict, and subsequently localize, all features that could possibly be queried. Additionally, the querying of the map 402 may be performed independently from the robot 102 and at any arbitrary time after the images are collected. That is, the map 402 produced by the robot 102 and its telemetry data (e.g., location, position, and time) may be communicated to a server and the server may perform any of the aforementioned processes, such as processing the images via the image encoder 310, embedding the respective feature embedding vectors 414, receiving queries and processing them via a text encoder 302, identifying similar feature embeddings, performing the image space projections (e.g., FIG. 5), and identifying the locations of the queried features. These processes may be performed instantaneously upon the server receiving the map and telemetry data or at a later time such as in response to a specific request such as a query 316. Use of an external server may enable querying of the map 402 even while the robot 102 is offline, not connected to WiFi or cellular networks, or busy with other tasks, however the present disclosure is not limited to such embodiment.

According to at least one non-limiting exemplary embodiment, feature embedding vectors 414 encoded into the map 402 may be given a time to live (“TTL”) and, upon the TTL expiring, are removed from the map 402. Assigning a TTL for a given feature embedding vector 414 ensures that queries onto the map 402 remain accurate to the current state of the environment. According to at least one non-limiting exemplary embodiment, a robot 102 capturing a new image at a location 406 that already includes a feature embedding vector 414 may cause the processor of the robot or server to replace the existing feature embedding with a new one determined via the capturing of a new image at the location 406.

Although the prior example was specific to an exit sign, there is no requirement that any particular feature be imaged for the above disclosure to be applicable. The goal of the system is to encode as many of the map 402 pixels as possible with a feature embedding vectors 324 from the trained image encoder 310 discussed under FIG. 3B. If the imaged scene is featureless (e.g., an empty hallway) the feature embedding vector 414 will reflect that, and similarly for feature rich scenes. The same concepts and methodology may be employed if the query instead was searching for doors, or any other imageable object or thing, instead of an exit specifically.

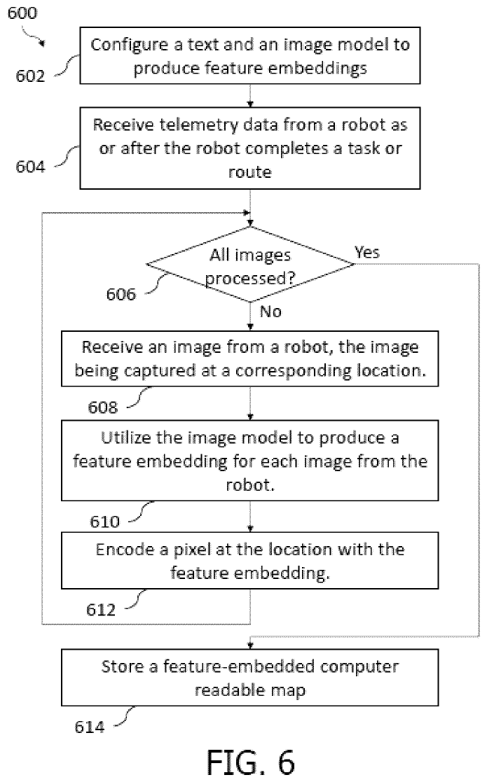

FIG. 6 is a process flow diagram illustrating a method 600 for a processor 130 to embed a computer readable map with feature information, according to an exemplary embodiment. Steps of method 600 may be effectuated via the processor 130 executing computer readable instructions stored in a memory. It is appreciated that the processor 130 may be the controller 118 of the robot 102 or a processor separate from the robot 102, such as a server, mobile device, or personal computer. It is additionally appreciated that the processor 130 may represent a plurality of processors distributed at different locations, such as a cloud server.

Step 602 begins with configuring a text and an image model to produce feature embeddings. Referring to FIG. 3A, these models may be trained with the use of two data sets: a textual dataset 302 containing various text prompts and an image data set 304 containing various images which correspond to the text prompts. For instance, the textual dataset 302 may contain “this is a dog” and correspondingly the image data set 304 may contain one or more images of a dog or dogs. When providing either the individual text prompts or individual images from the data sets 302, 304 respectively, the text and image encoders 306, 310 produce vectors 308, 312, respectively. The goal of the training is to configure the two encoders 306, 310 to produce the same or substantially similar corresponding vectors 308, 312, as illustrated in FIG. 3A, when provided with the respective text prompts and images that correspond to each other. A similarity matrix 314 may be formed using the two sets of vectors 308, 312. This matrix should include values of about 1 for any IₙTₙ pair (n being an arbitrary integer) to indicate the text input Tₙ corresponds to the image input Iₙ. Accordingly, the weights of the two encoders 306, 310 may be adjusted via back propagation to ensure the outputs for any IₙTₙ pair indicate correspondence. It is appreciated that other I_{N}T_{M} pairs may include values that indicate a high correspondence as there may be a plurality of images for a given text prompt in the data sets 302 and 304, or vice versa.

Returning to FIG. 6, block 604 includes the processor 130 receiving telemetry data from a robot 102 in real-time during performing a task or a route, or after the robot 102 completes a task or a route. The telemetry data includes, at least, the locations of the robot 102 over time and sensor data captured at those respective locations. The sensor data may include LiDAR ranging measurements and images. In some cases, this telemetry data may be communicated to the processor 130 via a live stream in real-time as the robot 102 navigates, or may be communicated as a package after the robot 102 has completed a task or route without limitation. In some cases where method 600 is performed separate to the robot 102, the robot 102 may be required to further wait until it is in an area of connectivity such as via Wi-Fi or cellular networks to receive the telemetry data.

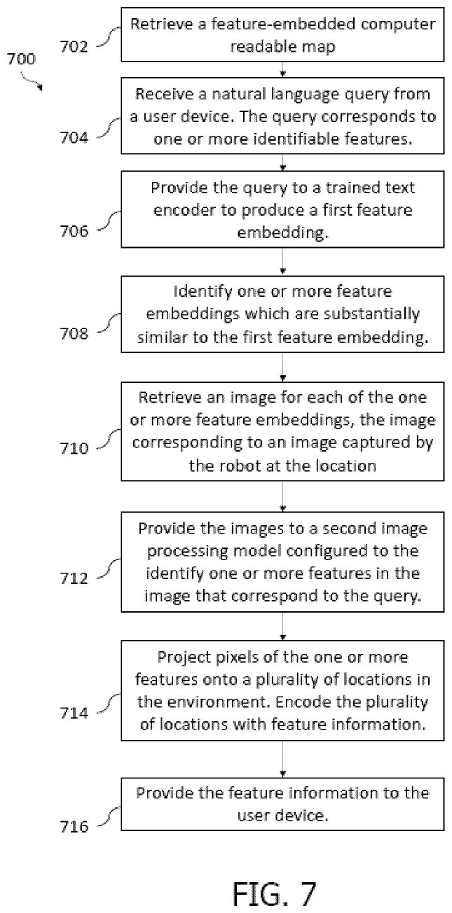

Block 606 initiates a for loop to determine if all images from the robot 102 have been processed in accordance with blocks 608-612 to produce feature embeddings. If all images have been processed, the processor 130 jumps to block 614 to store the map in memory for later use as described in FIG. 7. Otherwise, if there are still images that have not been processed, the processor continues to block 608.

Block 608 includes the processor 130 configured to execute computer readable instructions to receive an image from a camera 502 of a robot 102. The telemetry data received in block 604 includes a location of the robot when each image was captured.

Block 610 includes the processor 130 configured to execute computer readable instructions to utilize the image model, which was trained as discussed in FIG. 3A, to produce a feature embedding vector 414 for each image from the robot 102, as shown in FIG. 3B and FIG. 4. More specifically, the image is provided as input to the image encoder 310 and the output comprises a feature embedding vector 414. The image encoder 310 may include a network 200 which comprises a plurality of input nodes 202 that receive the image, a plurality of hidden nodes 206 which further process outputs from the input nodes, and a plurality of output nodes, wherein the values of the values of the output nodes constitute the feature embedding vector 414. The weights and connection efficacies are determined in block 302 via the training and are not adjusted in this step.

Block 612 includes the processor 130 configured to execute computer readable instructions to encode a pixel at the location with the feature embedding vector. The computer readable map 402 may be stored as a 2-dimensional matrix or a 3-dimensional volume of voxels with each cell (i.e., pixel or voxel) being encoded with a state. The state may include, for instance, free space, object/occupied, and undetected space. The states may further include the feature embedding vector, if one is determined for the given cell. It is appreciated that not all pixels of the computer readable map 402 includes a feature embedding vector 414 as these are only assigned to pixels which correspond to positions of the robot 102 during capture of the images. Other pixel states which modulate the behavior of the robot 102 (e.g., pixels which dictate actions, routes, mark landmarks, etc.) further are considered without limitation to the present disclosure. It is also appreciated that these feature embeddings do not indicate the presence of any particular or specific features and is a general vectorized representation of the visual scene which will be utilized to localize specific features of interest using methods discussed below.

Block 614 includes the processor 130 configured to execute computer readable instructions to store the feature-embedded computer readable map in a memory once all images have been processed in accordance with blocks 608-612. This feature embedded computer readable map comprises a computer readable map of the space with one or more pixels thereon having an embedded feature vector 414, the embedded feature vector 414 corresponding to an image encoder 310 output for an image captured by the robot 102 at the respective location of the one or more pixels. This feature embedded map will be utilized next in FIG. 7.

According to at least one non-limiting exemplary embodiment, a robot 102 may utilize a prior map of an environment with respective features embedded therein to navigate and update that computer readable map whenever it detects changes. In these instances, the telemetry data received in block 304 may further include a prior version(s) of the computer readable map 402 including prior feature embedding vectors. Accordingly, as the robot 102 utilizes the prior map to navigate it captures new images of the environment, potentially at new locations or in the same locations as before, wherein the new images may be utilized to either update prior feature embedding vectors or add new ones to the prior map. In some embodiments, feature embeddings may be removed from a map after a period of time (e.g., on the order of a day or week) to ensure they remain accurate representations of the physical space.

FIG. 7 is a process flow diagram illustrating a method 700 for a processor 130 to respond to a query using the feature embedded computer readable map produced via method 600 above, according to an exemplary embodiment. Steps of method 700 may be effectuated via the processor 130 executing computer readable instructions from a memory. It is appreciated that the processor 130 may be the controller 118 of the robot 102 or a processor separate from the robot 102, such as a server, mobile device, or personal computer. It is additionally appreciated that the processor 130 may represent a plurality of processors distributed at different locations, such as a cloud server. It is also presumed that method 600 has been executed such that a computer readable map 402 comprising a plurality of feature embedding vectors 414 encoded thereon is available.

Block 702 includes the processor 130 configured to execute computer readable instructions to retrieve a feature embedded computer readable map from a memory.

Block 704 includes the processor 130 receiving a natural language query from a user device. The natural language query may be input from a personal computer, smartphone, tablet, or a user interface 112 of the robot 102. In some embodiments, the query may be first communicated from the user device to a server which is coupled to both the user device and robot 102. In other cases, the query may be provided via a wired or direct connection to the robot 102. The query may further comprise of natural language rather than structured prompts. Accordingly, the query may be preprocessed via a language model in order to remove unnecessary terms, extract features or subjects of the prompt, and identify a task (e.g., find, count, identify, detect, etc.) with respect to the features.

The query corresponds to one or more identifiable features. A feature is considered herein as identifiable if it is able to be depicted in an image. For instance, temperature is generally not considered an identifiable feature as temperature cannot be seen with visible light (unless, for example, the robot 102 utilizes an infrared camera). Conversely, objects including people and animals may be identifiable as these are readily able to be depicted in imagery. It is appreciated that “detectable feature” does not refer to objects and things which are not present in the environment, but rather things which are undetectable in imagery. For instance, a car is considered a detectable feature given its ability to be represented in images even if the environment is an office space and there are no cars, wherein the query should respond indicating the lack of cars. In some embodiments, inputting queries may be structed via a graphical user interface such that a user selects from a predetermined list of quarriable features.

Block 706 includes the processor 130 configured to execute the computer readable instructions to provide providing the query to the trained text encoder 306 to produce a first feature embedding vector 322. This feature embedding vector 322 is similar to the feature embedding vectors 324 produced via the image encoder 310 in method 600, but is configured to receive textual inputs instead of images. The text encoder 306 was trained alongside the image encoder 310, as discussed in FIG. 3A above, to produce substantially similar feature embeddings for text and image pairs which correspond. Provided the new text query includes features which were imaged during construction of the feature embedded map in method 600, the locations where the features are imaged should comprise a feature embedding similar to the first feature embedding from the text encoder 306.

Stated another way, the encoders 306, 310 were concurrently trained such that they produce similar vectorized outputs for text and image pairs that correspond. Later, once these models are trained, they are used independently. The image encoder 310 is provided images from the robot 102 in method 600 to produce a first set of feature embeddings that are encoded into the map. In block 706, the text encoder 306 is provided with a new language query from a user, independent from the images from the robot 102. Consider, for example without limitation, that some images used for feature embedding depict a fridge, wherein these images would produce a plurality of feature embeddings via the image encoder 310. Assuming the models were trained properly, providing the text encoder 306 with a prompt which includes “fridge, refrigerator, freezer” etc., should produce a first feature embedding 322 that are similar to some of the plurality of feature embeddings 312 from the image encoder 310 which correspond to the fridge.

Block 708 includes the processor 130 identifying one or more feature embeddings of the feature-embedded computer readable map which are substantially similar to the first feature embeddings from the text encoder 306. In some implementations, substantial similarity may occur when a feature embedding of the computer readable map is within a threshold deviation from the first feature embedding from the text encoder 306. The threshold deviation may correspond to a per-element deviation for both vectors, i.e., each element of the vectors must be within 10% of each other to be considered substantially similar. In some implementations the two vectors can be compared to determine similarity via, for instance, a dot product or subtraction.

Block 710 includes the processor 130 retrieving an image for each of the one or more feature embeddings determined to be substantially similar to the first feature embedding, each of the images corresponding to an image captured by the robot at the location when it captured the image.

Block 712 includes the processor 130 providing the image(s) to a model configured to identify the one or more features specified by the query. This model is different than the prior models used by the text and the image encoders 306, 310, wherein this model is configured to receive an image and identify a specified feature therein via the use of, for instance, sematic segmentation or bounding boxes. It is appreciated that this model is wholly separate from the text and image encoders 306, 310 discussed previously and may be trained separately. The model receives features to be identified from the language model used to receive, and potentially pre-process, the natural language query. For instance, if the query includes “please find the plants and exits” the classes of plant and exit (or similar semantic labels) are passed to this image processing model. The image processing model used to identify the features of the query may output a set of pixels (e.g., bounding box or semantic segmentation) which depict the feature.

Block 714 includes the processor 130 configured to execute computer readable instructions to project the pixels of the one or more features onto a plurality of locations in the environment, wherein these locations being encoded with the feature information. In some embodiments, the projection may comprise a pixel-wise projection using other sensor data such as LiDARs. With reference to FIG. 5, which depicts a projection in two dimensions, consider section 508 of the image plane 504 is a bounding box which contains the feature(s) of interest. For each pixel within that bounding box, a ray 510 may be casted which extends from the camera 502 origin, through the pixel, and outward until it reaches a point or occupied cell (or is substantially close to one). This cell is then encoded with the feature information. This occurs for each pixel of the image that depicts the feature(s) and is repeated for each of the one or more images associated with the one or more locations where the feature embeddings match the first feature embedding. Although shown in FIG. 5 as a two-dimensional projection, it is preferable to perform this projection in 3 dimensions using both the vertical and horizontal dimensions of the image. Performing the projection in 3-dimensional space may yield a more accurate estimate of the true location of the given feature as well as the overall area that it encompasses. Other embodiments which employ different less precise and computationally simpler projection methods are discussed above regarding FIG. 5.

Block 716 includes the processor 130 configured to execute computer readable instructions to provide the feature information to the user device. The feature information may be presented based in part on the structure of the query. For instance, location-based queries which ask for the location of queried features may output a map of the space where the pixels encoded with feature data are represented with a different color to form a heat-map of feature detections. Alternatively, the output may be a list of coordinates or other numerical values. As another example, some queries may ask for a quantity or a detection of a feature, wherein the response may simply be the number of the feature occurrences instead of a map.

In some cases, the feature information may be directly provided to the user device. In other cases, the user device could correspond to the robot 102 and be utilized to command the robot 102 to navigate to various waypoints defined by the features. For example, methods 600-700 may produce a heat map of air conditioning vents, wherein the robot 102 may be commanded to navigate to one or more of these localized vents. This command may be provided via the user interface 112 of the robot 102 or a separate device coupled thereto.

Given a computer readable map having a plurality of feature embedding vectors therein, it may be leveraged to improve the ability of robots 102 to localize themselves and correct mapping errors. For instance, returning to FIG. 4, consider that the vast majority of pixels in the map 402 have a respective embedding vector 414. When initializing a robot 102, the current state of the art relies on the robot 102 detecting a notable landmark. Typically, these involve specific codes (e.g., QR codes or bar codes) affixed to the walls or floor, or particular fixtures such as overhead lights, charging stations, or homing beacons. Advantageously the present disclosure may enable a robot 102 to, without any prior localization information about itself, localize itself using an image taken in any arbitrary location in the map 402. Specifically, upon start-up (where the robot 102 has no prior knowledge of its current location), the robot 102 may capture one or more images of the environment. These images may be provided to the image encoder 310 to produce vectors 414 which may then be compared to the existing vectors already embedded into the map 402. Upon detecting a similarity between one or more embedded vectors of the map 402 and the incident vectors 414 from the current images, the robot 102 is able to narrow down possible locations for where it may be. In some cases the environment may include a plurality of very distinct features (e.g., a bakery aisle) located in only one place in the environment making the localization trivial. In other cases where the environment is less complex or feature-poor, the robot 102 may be required to be turned or moved slightly to capture more images of more features to attempt to localize itself with greater precision. In effect, instead of localizing itself using explicitly detected features like QR codes or structure support beams, the robot 102 may now consider hundreds or thousands of individual features all together in assessing where it likely is in the environment. Some implementations may utilize particle filters to estimate the position of the robot 102 as it acquires new images and narrows down the likely position of the robot 102 if multiple pixels comprise matching feature embeddings.

Stated differently, the above discussion regarding querying a map and finding features based on feature vectors encoded into the map enables robots 102 to query the maps themselves to determine where they are by capturing an image, providing it to the image encoder 310, and searching for pixels with similar vector encodings from prior images or navigation in the space.

The feature embeddings discussed herein may further enable maps produced by LiDAR data to become feature rich. LiDAR data currently only includes measurements of discrete points on the surfaces of objects, and contains no information about the material, size, shape, color, or any other property of the object beyond its presence. For simple robot navigation and object avoidance, this data is plenty sufficient to detect and avoid objects. As environments become larger and less complex, sensor drift and calibration issues may cause the map to be inaccurate.

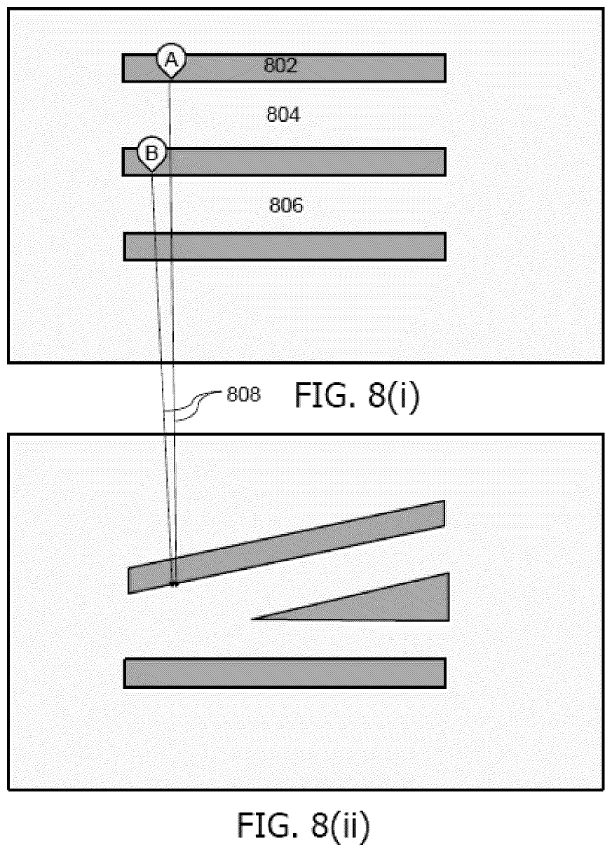

To illustrate the improvements on LiDAR maps, FIG. 8(i) depicts two aisles between three rectangular objects, according to an exemplary embodiment. FIG. 8(i) is considered an accurate map 802 of the physical space with no errors for use as reference in discussing FIG. 8(ii). The environment may contain tens of other aisles not shown in the figure. From the perspective of a LiDAR sensor, each individual aisle looks identical to other ones comprising of two walls of points on either side of the robot 102. In other words, using just the depicted LiDAR map 800, one could not decern if they are in the top aisle 804 or bottom aisle 806 due to the lack of distinguishing features.

Advantageously, the use of the feature embedding vectors generated from robot acquired and localized imagery can be leveraged to discern between the two aisles. Assuming the two aisles are not visually identical or incredibly similar, which is an extreme rarity in retail spaces, pixels of the top aisle 804 would have different embedded vectors than the bottom aisle 806 as a result of different visual features (i.e., products) being depicted in imagery. A robot 102 being powered on in a random one of the two aisles need only to capture an image, provide it to the image encoder 310, and compare the output vector 414 to vectors already encoded into the pixels of the two aisles. Upon detecting a similarity between the two vectors, the robot 102 may narrow down its location to one of the two aisles 804, 806—or any aisle in the overall environment with embedded vectors for that matter. The controller 118 may perform this similarity detection for multiple pixels of the map to improve its position estimation further. Since the map is constructed by LiDAR measurements and features are mapped to those LiDAR measurements, the controller 118 may determine its position relative to those points.

A difficulty with mapping large environments with a plurality of non-distinct features such as aisles as seen by LiDAR sensors arises when sensor drift cannot be countered with other localization methods. FIG. 8(ii) depicts two aisles in a large supermarket or warehouse, containing tens of other aisles, as mapped incorrectly by a robot 102, according to an exemplary embodiment. When performing a plurality of switchbacks through aisles, drift in encoders or gyroscopes may cause the robot 102 to perceive it has turned more/less than it actually has, therefore causing one aisle to be skewed diagonally as shown. Since the map is largely featureless from a LiDAR perspective, the robot 102 cannot tell which aisle it exited/entered from causing the ‘collapsed’ aisle situation depicted in FIG. 8(ii). Since triangular objects to exist in many environments, simply detecting them is not sufficient in determining a mapping error.

According to at least one non-limiting exemplary embodiment, the feature embeddings discussed herein may be utilized to partition an environment into semantic labels. For example, by querying the map to find “baking goods”, a vast majority of embedded feature vectors which are similar to the query would be clustered around a baking aisle with sugar, flour, chocolate, etc. These pixels may be assigned to a bounding box wherein the area of the bounding box may represent the “baking goods aisle/section”. Some outlier pixels with similar embedded feature vectors to the query which are not nearby any other pixel may be removed from the bounding box calculations. Although baking goods is used as an example, one skilled in the art may appreciate that any feature (e.g., electronics, dairy, paper products, etc.) could be utilized provided the model is configured to identify and correspond the semantic to an imaged feature.

It is appreciated that despite the error in map, the robot 102 did physically travel down both aisles 804 and 806 while capturing images and producing feature embeddings to the map. Assuming the two aisles are not identical, this would cause the robot 102 to embed two substantially different vectors onto the same pixel. For instance, consider the feature embedded vectors at the locations A and B shown in FIG. 8(i). These vectors would be produced based on the various products and features on the objects 802 (e.g., bakery aisle and a paper products aisle). The two feature vectors A and B for these locations produce different values as, presumably, there are different items or features in the different aisles. However, due to the error in the mapping, the two points are mapped to the same pixel. This is shown via arrows 808 from FIG. 8(i) to the single pixel they were mapped to in FIG. 8(ii). While it is possible for the embedding vector to change if the environment changes, it is unreasonable to expect such environmental changes within a single navigation of the space. Accordingly, if the robot 102 attempts to encode multiple vectors onto a single pixel, the controller 118 may verify that all of the vectors have a high similarity with each other. Detecting a substantial sudden deviation enables the controller 118 to detect delocalization or calibration issues. These may in turn prompt technician repair of the robot, remap the area, and/or manual map editing, wherein areas with conflicting embedded vectors may be highlighted for easier human review.

Although the present discussion was primarily focused on a collapsed aisle situation specific to retail or warehouse spaces, one skilled in the art may appreciate that this same method may be utilized in any robotic application to verify its location estimations. That is, any time the robot 102 estimates that it has traveled back to a place it previously was, the two vectors produced at that place and/or around it should be similar and substantial deviations would indicate a mapping error. Specifically that a loop closure might not have occurred where estimated.

A common method used in the art of robotic navigation is loop closures, or places where a robot 102 travels twice thereby ‘closing a loop’. Knowing that a robot 102 has returned to a previous location constrains pose estimations, improving the overall accuracy of the path estimation. Advantageously the feature embedding vectors described herein enable a robot 102 to either detect when a loop closure has occurred or determine one did not occur based on a current image producing a feature vector which matches or does not match, respectively, the vector already embedded in the map.

According to at least one non-limiting exemplary embodiment, a robot may produce multiple embedding vectors 414 for a given pixel if the robot 102 travels near that pixel multiple times and images the space multiple times. Since the environment is not assumed to have undergone massive change in a short time, the vectors produced at these locations should be similar and therefore may be averaged into a singular vector for that pixel to reduce the memory usage of the map and its encodings. Detecting a substantial difference between the vector embedded in the map and one currently generated by an image at the estimated same location may cause the robot to identify a delocalization or errors in its own localization estimations.

FIGS. 8i-ii illustrate the practical deployment scenario where the robot 102 utilizes the feature-embedded map for initialization and error detection. Upon power-on, the robot 102 captures an initial image via camera 502 and generates a feature embedding vector 324 using image encoder 310. The controller 118 queries the computer-readable map 402 by comparing this current vector 324 against all stored vectors 414. When a match is found exceeding the similarity threshold, the controller 118 retrieves the associated physical location coordinate and sets this as the robot's initial pose. This enables “initialize from anywhere” capability without requiring the robot to start at a predetermined location marked by QR codes or charging stations. For mapping error correction, during subsequent navigation, the robot 102 periodically captures images and generates new feature embedding vectors. When the controller 118 detects that a newly generated vector at a previously mapped location differs substantially (e.g., cosine similarity below 0.7) from the originally stored vector 414 at that location, it flags a potential mapping error. This discrepancy may indicate environmental changes, such as a collapsed aisle in a warehouse or moved inventory. The controller 118 then triggers a remapping routine for that region or generates an alert to a remote monitoring system. By continuously comparing current feature embeddings against the stored map embeddings, the robot 102 autonomously validates map integrity and maintains localization accuracy over time.

The feature-embedded map system integrates seamlessly with conventional robot navigation architectures. The navigation units 106 receive the localization estimate derived from feature embedding matching as an input pose, which is fused with odometry data from sensor units 114 using a Kalman filter or particle filter. The feature-embedded map 402 is stored in memory 120 alongside traditional occupancy grid maps, with the controller 118 maintaining correspondence between map cells and feature embedding vectors 414. When planning paths, the navigation units 106 can query the map using natural language commands received through user interface units 112, converting them to target locations via the text encoder 306 and similarity search process. This allows human operators to direct robots using intuitive commands like “navigate to the loading dock near the red container” without requiring manual map annotation. The system also publishes localization confidence metrics based on similarity scores to the communications unit 116, enabling remote monitoring systems to assess when manual intervention may be needed. This integration preserves existing investments in robot hardware and software while adding the advanced localization and querying capabilities disclosed herein.

It will be recognized that while certain aspects of the disclosure are described in terms of a specific sequence of steps of a method, these descriptions are only illustrative of the broader methods of the disclosure, and may be modified as required by the particular application. Certain steps may be rendered unnecessary or optional under certain circumstances. Additionally, certain steps or functionality may be added to the disclosed embodiments, or the order of performance of two or more steps permuted. All such variations are considered to be encompassed within the disclosure disclosed and claimed herein.

While the above detailed description has shown, described, and pointed out novel features of the disclosure as applied to various exemplary embodiments, it will be understood that various omissions, substitutions, and changes in the form and details of the device or process illustrated may be made by those skilled in the art without departing from the disclosure. The foregoing description is of the best mode presently contemplated of carrying out the disclosure. This description is in no way meant to be limiting, but rather should be taken as illustrative of the general principles of the disclosure. The scope of the disclosure should be determined with reference to the claims.

While the disclosure has been illustrated and described in detail in the drawings and foregoing description, such illustration and description are to be considered illustrative or exemplary and not restrictive. The disclosure is not limited to the disclosed embodiments. Variations to the disclosed embodiments and/or implementations may be understood and effected by those skilled in the art in practicing the claimed disclosure, from a study of the drawings, the disclosure and the appended claims.

It should be noted that the use of particular terminology when describing certain features or aspects of the disclosure should not be taken to imply that the terminology is being re-defined herein to be restricted to include any specific characteristics of the features or aspects of the disclosure with which that terminology is associated. Terms and phrases used in this application, and variations thereof, especially in the appended claims, unless otherwise expressly stated, should be construed as open ended as opposed to limiting. As examples of the foregoing, the term “including” should be read to mean “including, without limitation,” “including but not limited to,” or the like; the term “comprising” as used herein is synonymous with “including,” “containing,” or “characterized by,” and is inclusive or open-ended and does not exclude additional, unrecited elements or method steps; the term “having” should be interpreted as “having at least;” the term “such as” should be interpreted as “such as, without limitation;” the term ‘includes” should be interpreted as “includes but is not limited to;” the term “example” is used to provide exemplary instances of the item in discussion, not an exhaustive or limiting list thereof, and should be interpreted as “example, but without limitation;” adjectives such as “known,” “normal,” “standard,” and terms of similar meaning should not be construed as limiting the item described to a given time period or to an item available as of a given time, but instead should be read to encompass known, normal, or standard technologies that may be available or known now or at any time in the future; and use of terms like “preferably,” “preferred,” “desired,” or “desirable,” and words of similar meaning should not be understood as implying that certain features are critical, essential, or even important to the structure or function of the present disclosure, but instead as merely intended to highlight alternative or additional features that may or may not be utilized in a particular embodiment. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should be read as “and/or” unless expressly stated otherwise. The terms “about” or “approximate” and the like are synonymous and are used to indicate that the value modified by the term has an understood range associated with it, where the range may be ±20%, ±15%, ±10%, ±5%, or ±1%. The term “substantially” is used to indicate that a result (e.g., measurement value) is close to a targeted value, where close may mean, for example, the result is within 80% of the value, within 90% of the value, within 95% of the value, or within 99% of the value. Also, as used herein “defined” or “determined” may include “predefined” or “predetermined” and/or otherwise determined values, conditions, thresholds, measurements, and the like.

What is claimed is:

1. A method for localizing a mobile robot in a physical environment without requiring artificial markers, comprising:
powering on the mobile robot at an unknown location within the physical environment;
capturing, via a camera physically mounted on the mobile robot, a first image of the physical environment from the unknown location;
encoding, by an image encoder implemented on a processor of the mobile robot, the first image into a first feature embedding vector;
accessing, from a memory of the mobile robot, a computer-readable map representing the physical environment, the map comprising a plurality of feature embedding vectors generated from images previously captured by the mobile robot during prior navigation within the physical environment, wherein each feature embedding vector is stored at a respective physical location coordinate in the map;
determining a degree of similarity between the first feature embedding vector and each of the plurality of feature embedding vectors in the computer-readable map;
identifying, based on the degree of similarity, one or more matching feature embedding vectors from the computer-readable map that exceed a similarity threshold, wherein the identified matching feature embedding vectors correspond to one or more pixels in the first image that depict features at the unknown location; and
localizing the mobile robot at the unknown location based on position of the mobile robot relative to the one or more pixels determined to have the degree of similarity, wherein the localizing enables the mobile robot to autonomously navigate within the physical environment.

2. The method of claim 1, wherein,
the image encoder is a pre-trained neural network model configured to encode images into feature embedding vectors, and
the computer-readable map is generated by providing, to the image encoder, a plurality of images previously captured by the mobile robot at locations measured by the robot during a prior mapping traversal of the physical environment.

3. The method of claim 1, further comprising:
receiving, at a user device communicatively coupled to the mobile robot, a natural language query describing one or more features within the physical environment;
providing the natural language query to a text encoder to generate a query feature embedding vector;
comparing the query feature embedding vector to the plurality of feature embedding vectors in the computer-readable map;
identifying one or more locations in the computer-readable map where feature embedding vectors are substantially similar to the query feature embedding vector; and
directing the mobile robot to navigate to one of the identified locations based on the natural language query.

4. The method of claim 1, wherein localizing the mobile robot further comprises:
projecting, from the camera via ray-casting, one or more rays through pixels of the first image corresponding to the identified matching feature embedding vectors;
determining three-dimensional intersection points of the one or more rays with the physical environment; and
refining the localization by correlating the intersection points with the respective physical location coordinate of the identified matching feature embedding vectors.

5. The method of claim 1, further comprising:
detecting a mapping inconsistency by comparing the first feature embedding vector to a previously stored feature embedding vector at the respective physical location coordinate;
determining that the first feature embedding vector differs from the previously stored feature embedding vector by more than a threshold amount; and
generating an alert or triggering a remapping operation to correct mapping errors in the computer-readable map.

6. The method of claim 1, further comprising:
creating a heat map of the physical environment by counting, for each of a plurality of pixel representing a discretized region of the physical environment, a number of times a feature embedding vector is projected into the pixel;
encoding the count for each pixel with a visual indicator representing feature occurrence density; and
storing the heat map in the computer-readable map to enable analysis of feature distribution throughout the physical environment.

7. A non-transitory computer-readable medium comprising computer-readable instructions stored thereon that, when executed by at least one processor of a mobile robot, cause the processor to:
detect a power-on event of the mobile robot at an unknown location within a physical environment;
receive, from a camera physically mounted on the mobile robot, a first image of the physical environment captured from the unknown location;
encode the first image into a first feature embedding vector using an image encoder implemented on the processor;
access, from a memory of the mobile robot, a computer-readable map representing the physical environment, the map comprising a plurality of feature embedding vectors generated from images previously captured by the mobile robot during prior navigation within the physical environment, wherein each feature embedding vector is stored at a respective physical location coordinate in the map;
determine a degree of similarity between the first feature embedding vector and each of the plurality of feature embedding vectors in the computer-readable map;
identify, based on the degree of similarity, one or more matching feature embedding vectors from the computer-readable map that exceed a similarity threshold, wherein the identified matching feature embedding vectors correspond to one or more pixels in the first image that depict features at the unknown location; and
localize the mobile robot at the unknown location based on position of the mobile robot relative to the one or more pixels determined to have the degree of similarity, wherein the localizing enables the mobile robot to autonomously navigate within the physical environment.

8. The non-transitory computer-readable medium of claim 7, wherein,
the image encoder is a pre-trained neural network model stored in the memory, and
the instructions further cause the processor to generate the computer-readable map by encoding a plurality of images previously captured by the mobile robot at locations measured by the robot during a prior mapping traversal of the physical environment using the image encoder.

9. The non-transitory computer-readable medium of claim 7, wherein the computer-readable instructions further cause the processor to:
receive, from a user device communicatively coupled to the mobile robot via a communication interface, a natural language query describing one or more features within the physical environment;
encode the natural language query into a query feature embedding vector using a text encoder;
compare the query feature embedding vector to the plurality of feature embedding vectors in the computer-readable map;
identify one or more locations in the computer-readable map where feature embedding vectors are substantially similar to the query feature embedding vector; and
transmit navigation instructions to an actuator of the mobile robot to autonomously navigate to one of the identified locations based on the natural language query.

10. The non-transitory computer-readable medium of claim 7, wherein the computer-readable instructions further cause the processor to,
refine the localization by:
projecting, from the camera via ray-casting, one or more rays through pixels of the first image corresponding to the identified matching feature embedding vectors;
calculating three-dimensional intersection points of the one or more rays with the physical environment; and
correlating the intersection points with the respective physical location coordinate of the identified matching feature embedding vectors to determine a refined pose estimate of the mobile robot.

11. The non-transitory computer-readable medium of claim 7, wherein the computer-readable instructions further cause the processor to:
detect a mapping inconsistency by retrieving a previously stored feature embedding vector associated with the respective physical location coordinate;
compare the first feature embedding vector to the previously stored feature embedding vector;
determine that the first feature embedding vector differs from the previously stored feature embedding vector by more than a threshold amount;
generate an alert signal indicating a mapping error; and
trigger a remapping routine or transmit the alert to a remote monitoring system to correct mapping errors in the computer-readable map.

12. The non-transitory computer-readable medium of claim 7, wherein the computer-readable instructions further cause the processor to:
discretize the physical environment into a plurality of pixels;
count, for each pixel, a number of times a feature embedding vector is projected into the pixel during localization process;
generate a heat map by encoding each count with a visual indicator representing feature occurrence density; and
store the heat map in the computer-readable map to enable analysis and visualization of feature distribution throughout the physical environment.

13. The non-transitory computer-readable medium of claim 7, wherein the computer-readable instructions further cause the processor to:
retrieve the similarity threshold from a configuration stored in the memory;
dynamically adjust the similarity threshold based on environmental conditions, feature density, or map quality metrics; and
apply the adjusted similarity threshold when identifying the one or more matching feature embedding vectors.

14. The non-transitory computer-readable medium of claim 7, wherein the computer-readable instructions further cause the processor to:
determine that the mobile robot is localized by identifying multiple matching feature embedding vectors at nearby physical location coordinates;
update an odometry estimate of the mobile robot based on the localization;
transmit correction signals to a navigation unit of the mobile robot to correct accumulated odometry drift; and
resume autonomous navigation with improved localization accuracy.

15. The non-transitory computer-readable medium of claim 7, wherein the computer-readable instructions further cause the processor to:
capture a plurality of images over time from the camera as the mobile robot navigates the physical environment;
encode each of the plurality of images into corresponding feature embedding vectors;
store each feature embedding vector at the physical location coordinate where the corresponding image was captured; and
continuously update the computer-readable map with newly generated feature embedding vectors to expand map coverage and improve localization robustness over successive traversals of the physical environment.
